(19) United States
(12) Patent Application Publication
(10) Pub. No.: US 2017/0235580 A1
(43) Pub. Date: Aug. 17, 2017

(54) SYSTEM FOR SPECULATIVE EXECUTION EVENT COUNTER CHECKPOINTING AND RESTORING

(71) Applicant: Intel Corporation, Santa Clara, CA (US)

(72) Inventors: Laura A. Knauth, Portland, OR (US); Ravi Rajwar, Portland, OR (US); Peggy J. Irelan, Chandler, AZ (US); Konrad K. Lai, Vancouver, WA (US); Martin G. Dixon, Portland, OR (US)

(21) Appl. No.: 15/586,930

(22) Filed: May 4, 2017

Related U.S. Application Data
(63) Continuation of application No. 13/365,104, filed on Feb. 2, 2012.
Application No. 13/365,104 is a continuation-in-part of application No. 12/655,204, filed on Dec. 26, 2009, now Pat. No. 8,924,692.

(51) Int. Cl. G06F 9/38; G06F 9/46; G06F 12/084; G06F 13/42; G06F 9/30; G06F 12/0875

(52) U.S. Cl. CPC G06F 9/3863; G06F 9/3009; G06F 9/3855; G06F 9/30101; G06F 9/30043; G06F 9/3802; G06F 9/3016; G06F 9/384; G06F 9/30087; G06F 12/0875; G06F 12/084; G06F 13/4282; G06F 9/467; G06F 2212/452; G06F 2212/62; G06F 2213/0026

(57) ABSTRACT

An example system for speculative execution event counter checkpointing and restoring may include a plurality of processors, a first interconnect to couple two or more of the plurality of processors, a second interconnect to couple one or more of the plurality of processors to one or more other system components, and a system memory coupled to one or more of the processors. At least one processor of the plurality of processors may include: a plurality of symmetric cores, at least one of the symmetric cores to simultaneously process a plurality of threads and to perform out-of-order instruction processing for the plurality of threads; at least one shared cache circuit to be shared among two or more the of symmetric cores; and event counter circuitry comprising: a plurality of event counters including programmable event counters and fixed event counters; one or more configuration registers to store configuration data to specify an event type to be counted by the programmable event counters, wherein at least one of the one or more configuration registers is to store configuration data for a plurality of the programmable event counters. The processor may further include transactional memory circuitry to process transactional memory operations including load operations and store operations, the transactional memory circuitry to process a transaction begin instruction to indicate a start of a transactional execution region of a program, a transaction end instruction to indicate an end of the transactional execution region, and a transaction abort instruction to abort processing of the transactional execution region. The processor may further include transaction checkpoint circuitry to store a processor state at the start of the transactional execution region of the program, the processor state including values of one or more of the event counters. The processor may further include lock elision circuitry to cause critical sections of the program to execute as transactions on multiple threads without acquiring a lock, the lock elision circuitry to cause the critical sections to be re-executed non-speculatively using one or more locks in response to detecting a transaction failure.

### CROSS-REFERENCE TO RELATED APPLICATIONS

This application is a continuation of U.S. patent application Ser. No. 13/365,104 filed on Feb. 02, 2012, titled “Method, Apparatus and System for Speculative Execution Event Counter Checkpointing and Restoring,” which is a continuation-in-part of U.S. patent application Ser. No. 12/655,204, filed Dec. 26, 2009, issued as U.S. Pat. No. 8,924,692, titled “Event Counter Checkpointing and Restoring.” Both above-referenced applications are incorporated by reference herein.

### FIELD

This disclosure pertains to the field of integrated circuits and, in particular, to speculative execution and control of event counters. Embodiments of the invention relate to methods of event counting or logic devices having event counters. In particular, one or more embodiments relate to methods of event counting with checkpointing and restoring or logic devices having event counters that are capable of being checkpointed and restored.

### BACKGROUND INFORMATION

Advances in semi-conductor processing and logic design have permitted an increase in the amount of logic that may be present on integrated circuit devices. As a result, computer system configurations have evolved from a single or multiple integrated circuits in a system to multiple cores and multiple logical processors present on individual integrated circuits. A processor or integrated circuit typically comprises a single processor die, where the processor die may include any number of cores or logical processors.

The ever increasing number of cores and logical processors on integrated circuits enables more software threads to be concurrently executed. However, the increase in the number of software threads that may be executed simultaneously have created problems with synchronizing data shared among the software threads. One common solution to accessing shared data in multiple core or multiple logical processor systems comprises the use of locks to guarantee mutual exclusion across multiple accesses to shared data. However, the ever increasing ability to execute multiple software threads potentially results in false contention and a serialization of execution.

For example, consider a hash table holding shared data. With a lock system, a programmer may lock the entire hash table, allowing one thread to access the entire hash table. However, throughput and performance of other threads is potentially adversely affected, as they are unable to access any entries in the hash table, until the lock is released. Alternatively, each entry in the hash table may be locked. Either way, after extrapolating this simple example into a large scalable program, it is apparent that the complexity of lock contention, serialization, fine-grain synchronization, and deadlock avoidance become extremely cumbersome burdens for programmers.

Another recent data synchronization technique includes the use of transactional memory (TM). Often transactional execution includes executing a grouping of a plurality of micro-operations, operations, or instructions atomically. In the example above, both threads execute within the hash table, and their memory accesses are monitored/tracked. If both threads access/alter the same entry, conflict resolution may be performed to ensure data validity. One type of transactional execution includes Software Transactional Memory (STM), where tracking of memory accesses, conflict resolution, abort tasks, and other transactional tasks are performed in software, often without the support of hardware. Another type of transactional execution includes a Hardware Transactional Memory (HTM) System, where hardware is included to support access tracking, conflict resolution, and other transactional tasks.

A technique similar to transactional memory includes hardware lock elision (HLE), where a locked critical section is executed tentatively without the locks. And if the execution is successful (i.e. no conflicts), then the result are made globally visible. In other words, the critical section is executed like a transaction with the lock instructions from the critical section being elided, instead of executing an atomically defined transaction. As a result, in the example above, instead of replacing the hash table execution with a transaction, the critical section defined by the lock instructions are executed tentatively. Multiple threads similarly execute within the hash table, and their accesses are monitored/tracked. If both threads access/alter the same entry, conflict resolution may be performed to ensure data validity. But if no conflicts are detected, the updates to the hash table are atomically committed.

As can be seen, transactional execution and lock elision have the potential to provide better performance among multiple threads. However, HLE and TM are relatively new fields of study with regards to microprocessors. And as a result, HLE and TM implementations in processors have not been fully explored or detailed.

Some processors include event counters. The event counters count events that occur during execution. By way of example, the events may include instructions retired, branch instructions retired, cache references, cache misses, or bus accesses, to name just a few examples.

FIG. 1 is a block diagram illustrating a conventional approach 100 for counting events in a logic device. The events occur in sequence from top to bottom during execution time 102.

Conventional event counts 104 of a conventional event counter are shown to the right-hand side in parenthesis. Initially, M events 106 occur and are counted during committed execution. Subsequently, N events 108 occur and are counted during execution that is ultimately aborted and/or un-committed. Bold lines 110 demarcate the N events that occur during the execution that is ultimately aborted and/or un-committed. As shown, the event counter would count through the values (M−1), (M), (M+1), (M+2), . . . (M+N), (M+N+1).

The conventional event counter counts all events that occur during both committed and un-committed execution in the final event count. Notice in the illustration that the event counter counts the event immediately following the N events that occur during the execution that is ultimately aborted and/or un-committed as (M+N+1).

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a block diagram illustrating a conventional approach for counting events in a logic device.

FIG. 2 is a block flow diagram of an embodiment of a method of counting events in a logic device.

FIG. 3 is a block diagram of an embodiment of a logic device.

FIG. 4 is a block diagram illustrating an example embodiment of counting events during speculative execution performed in conjunction with branch prediction.

FIG. 5 is a block diagram illustrating an example embodiment of counting events during speculative execution performed in conjunction with execution in a transactional memory.

FIG. 6 is a block diagram of an embodiment of a logic device having an embodiment of a first event counter to exclude events during un-committed execution from an event count and an embodiment of a second event counter to include events counted during un-committed execution in an event count.

FIG. 7 is a block diagram of an embodiment of a configurable logic device.

FIG. 8 is a block diagram of a first example embodiment of a suitable computer system.

FIG. 9 is a block diagram of a second example embodiment of a suitable computer system.

FIG. 10 illustrates an embodiment of a suitable multiprocessor computer system.

FIG. 11 illustrates another embodiment of a suitable multiprocessor computer system.

FIG. 12 illustrates another embodiment of a suitable multiprocessor computer system.

FIG. 13 illustrates an embodiment of a logical representation of a system including processor having multiple processing elements (2 cores and 4 thread slots)

FIG. 14 illustrates an embodiment of a logical representation of modules for a processor to provide counters for speculative execution.

FIG. 15 illustrates an embodiment of a programmable register to control event counter tracking and performance tuning.

FIG. 16 illustrates an embodiment of a flow diagram for controlling an event counter during speculative execution and performance tuning based thereon.

FIG. 17 illustrates another embodiment of a flow diagram for controlling an event counter during speculative execution and performance tuning based thereon.

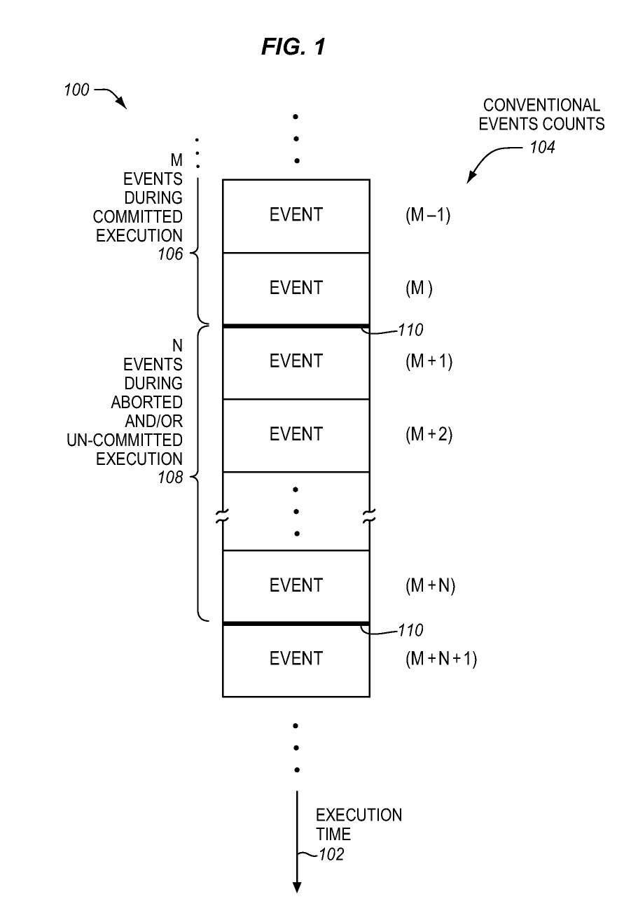

### DETAILED DESCRIPTION

In the following description, numerous specific details are set forth, such as examples of specific types of specific processor configurations, specific hardware structures, specific architectural and micro architectural details, specific register configurations, specific lock instructions, specific types of hardware monitors/tracking, specific data buffering techniques, specific critical section execution techniques, etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific cache coherency details, specific lock instruction and critical section identification techniques, specific compiler makeup and operation, specific transactional memory structures, specific/detailed instruction implementation and Instruction Set Architecture definition, and other specific operational details of processors haven't been described in detail in order to avoid unnecessarily obscuring the present invention.

Although the following embodiments are described with reference to a processor, other embodiments are applicable to other types of integrated circuits and logic devices. Similar techniques and teachings of embodiments described herein may be applied to other types of circuits or semiconductor devices that can benefit from higher throughput and performance. For example, the disclosed embodiments are not limited to computer systems. And may be also used in other devices, such as handheld devices, systems on a chip (SOC), and embedded applications. Some examples of handheld devices include cellular phones, Internet protocol devices, digital cameras, personal digital assistants (PDAs), and handheld PCs. Embedded applications include a microcontroller, a digital signal processor (DSP), a system on a chip, network computers (NetPC), set-top boxes, network hubs, wide area network (WAN) switches, or any other system that can perform the functions and operations taught below.

The method and apparatus described herein are for supporting lock elision and transactional memory. Specifically, lock elision (LE) and transactional memory (TM) are discussed with regard to transactional execution with a microprocessor, such as processor 1300. Yet, the apparatus' and methods described herein are not so limited, as they may be implemented in conjunction with alternative processor architectures, as well as any device including multiple processing elements. For example, LE and/or RTM may be implemented in other types of integrated circuits and logic devices. Or it may be utilized in small form-factor devices, handheld devices, SOCs, or embedded applications, as discussed above.

The discussion herein is often in reference to event counters (and control thereof). Event counters, which may also be referred to as performance or event monitors, are utilized to track events, which may encompass actual instances of an occurrence or duration of (or between) instances of an occurrence. An event, in one embodiment, includes any trackable or countable occurrence in an integrated circuit device, such as an architecture, microarchitectural, or other event.

As a specific illustrative example, an event includes any instruction, operation, occurrence, or action in a processing device that introduces latency. A few examples of common events in a microprocessor include: an instruction retirement, a low-level cache miss, a secondary cache miss, a high-level cache miss, a cache access, a cache snoop, a branch misprediction, a fetch from memory, a lock at retirement, a hardware pre-fetch, a front-end store, a cache split, a store forwarding problem, a resource stall, a writeback, an instruction decode, an address translation, an access to a translation buffer, an integer operand execution, a floating point operand execution, a renaming of a register, a scheduling of an instruction, a register read, and a register write, a buffer overflow, a persistent access, etc..

As another illustrative example, an event counter tracks duration counts. In one scenario, a performance monitor (or counter) determines contribution of a feature through duration counts.

Some performance monitor events are defined to count each cycle that something of interest is happening. This yields a duration count instead of an instance count (i.e. the number of events). Two such counts are the cycles that a state machine is active, e.g. page walk handler, lock state machine, and cycles that there's one or more entries in a queue, e.g. the bus's queue of outstanding cache misses. These examples measure time in an execution stage, and do not necessarily measure a retirement pushout, unless the execution is at retirement, which is the case for the lock state machine. This form of characterization is potentially usable in the field to evaluate benchmark-specific costs.

As yet another illustrative example, a performance monitor or event counter is to measure/determine a number of instruction retirements or retirement pushout. Retirement pushouts are useful in determining contribution of events and features on a local scale, as well as extrapolating that measurement to a global performance scale. Retirement pushout occurs when one operation does not retire at an expected time or during an expected cycle. For example, for a sequential pair of instructions (or micro-ops), if the second instruction does not retire as soon as possible after the first (normally in the same cycle, or if retirement resources are constrained, the next cycle), then the retirement is considered to be pushed out. Retirement pushout provides a backward-looking, “regional” (rather than purely local) measurement of contribution to a critical path. It is backward looking in the sense that retirement pushout is cognizant of the overlap of all operations which were retired prior to some point in time. If two operations with a local stall cost of 50 begin one cycle apart, the retirement pushout for the second is at most one, rather than 50. The actual measurement of retirement pushout may vary depending on when the pushout is measured from. In one instance, the measurement is from an occurrence of an event. In another embodiment, the measurement of pushout is from when the instruction or operation should have been retired. In yet another embodiment, retirement pushout is measured simply by counting the number of occurrences of retirement pushouts, as to retirement pushout of sequential operations. There are various ways to measure/derive a per-instance contribution through retirement pushout. For example, cycles between sequential operations may be tracked by an event counter. Or an operation/instruction is tagged (i.e. identified due to some special attribute or some event caused thereby) and a number of cycles after its expected retirement is counted. Furthermore, a number of operations or instructions that are pushed out beyond a threshold are counted as events/instances.

However, event counters may be utilized to track any type of information regarding a processing device. For example, the counters and methods described herein may be utilized to determine the effect of a critical section. As an illustrative scenario, two counters are set to count instruction retirements of sequential operations over a threshold duration. Upon starting a speculative code region (as discussed in more detail below), one of the counters is stored/checkpointed as a rollback count, while the other (second) counter continues to accumulate without a checkpoint. At the end of the speculative code region (either by commit or abort), the difference between the final count and the stored, rollback count represents the number of instructions retirements over the threshold for the speculative code region (i.e. a critical path performance indicator for the speculative code region). As a result, the architecture, microarchitecture, code, or speculative execution mode may be tuned (i.e. altered or modified) based on such performance indicators.

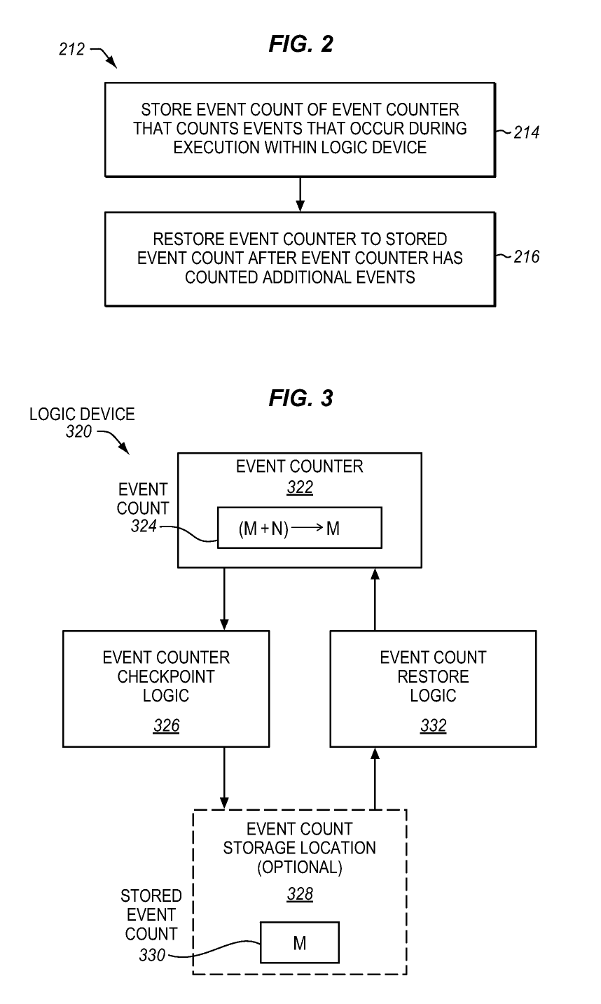

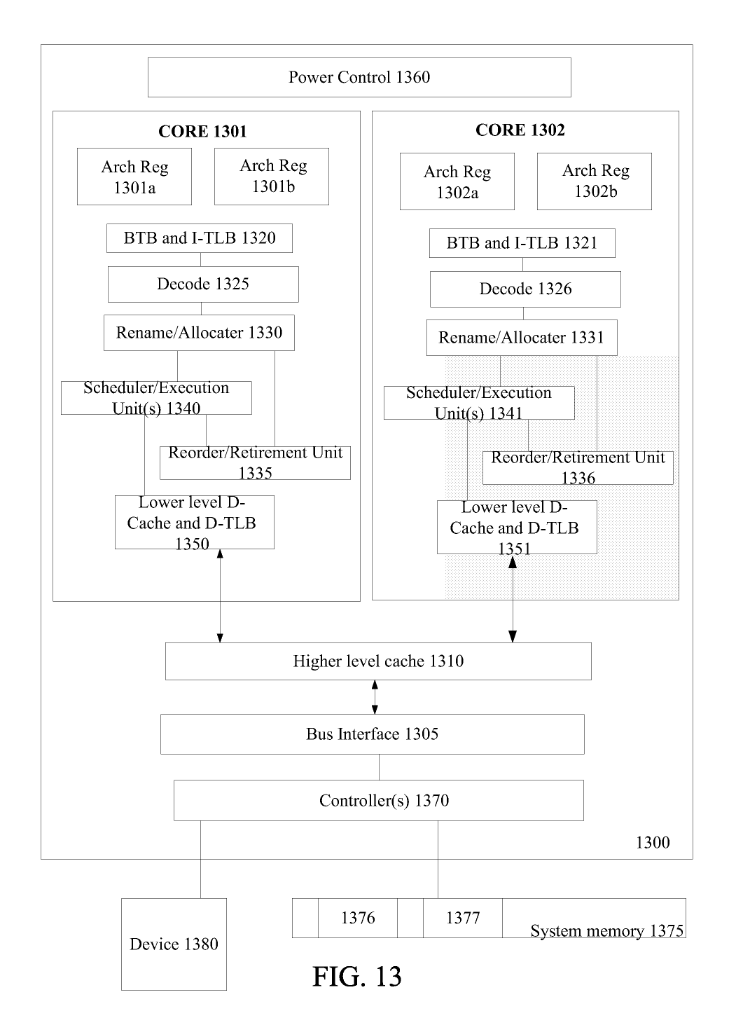

FIG. 2 is a block flow diagram of an embodiment of a method 212 of counting events in a logic device, such as a processor of FIG. 13 or other integrated circuit device. In various embodiments, the method may be performed by a general-purpose processor, a special-purpose processor (e.g., a graphics processor or a digital signal processor), a hardware accelerator, a controller, or another type of logic device, such as the exemplary devices listed herein or any other known processing device.

At block 214, an event count of an event counter is stored. As in the example above, any occurrence may cause an event count to be stored. In one embodiment, as part of a begin speculative code region instruction (e.g. XBEGIN and XACQUIRE discussed in more detail below) the event count is stored. Here, as part of the predefined flow of a ISA instruction, one or more event counters are check pointed. As another example, a control register for a counter is set to indicate that the associated counter is to be check pointed upon beginning a speculative code region. And in response to the register being set and a start speculative code region instruction being decoded, the event count is stored. In other words, control for each counter is able to independently dictate if each counter is to be checkpointed. And when a specific instruction is detected by decode logic, registers that are so dictated have their event counts stored in case of an abort or performance determination.

As a result, if an abort occurs during execution of the speculative code region, then the event counter is restored to the stored event count, at block 216. Typically, the event counter has counted additional events between the time the event count was stored and the time the event count was restored. Advantageously, the ability to store and restore the event count of the event counter may allow certain events to be excluded from the final event count. In one or more embodiments, events during aborted and/or un-committed execution, which is not committed to final program flow, may be excluded. For example, in one or more embodiments, events during aborted and/or un-committed speculative execution may be excluded from the final event count. Alternatively, events during other types of execution may optionally be excluded from the final event count. As discussed above, two counters may be utilized to track the same event (or type of events). And in one scenario, one of the two counters is stored and restored according to the flows of FIG. 2 upon an abort of a speculative code region. Consequently, the difference between the two counters indicates the event count associated with execution of the speculative code region. From this information, any known performance metric may be determined. For example, the cost of the speculative code region's execution to a critical path. And if such cost is too great (i.e. the benefit of execution a critical section with lock elision is too high), then lock elision may be turned off (or at least the critical section that elision was performed for is avoided in the future).

FIG. 3 is a block diagram of an embodiment of a logic device 320. In various embodiments, the logic device may include a general-purpose processor, a special-purpose processor (e.g., a graphics processor or a digital signal processor), a hardware accelerator, a controller, or another type of logic device. In one or more embodiments, the logic device has out-of-order execution logic.

The logic device has an event counter 322. The event counter may count events that occur during execution within the logic device, such as the exemplary events described above. For example, the counter may be incremented each time an event of a specific type occurs. As a result, the event counter at a given time includes (holds) an event count 324.

As mentioned above, event counters are sometimes referred to as event monitoring counters, performance monitoring counters, or simply performance counters. Further information on particular examples of suitable performance monitoring counters, if desired, is available in Intel(R) 64 and IA-32 Architectures Software Developer's Manual, Volume 3B, System Programming Guide, Part 2, Order Number 253669-032US, September 2009. See e.g., Chapters 20 and 30, and Appendices A-B. In one or more embodiments, the event counter is a hardware counter and/or includes circuitry.

Event counter checkpoint logic 326 is coupled with, or otherwise in communication with, the event counter 322. The event counter checkpoint logic 326 is operable (or configured) to store the event count 324 of the event counter 322 at a specific point in time (i.e. a checkpoint). The term “checkpoint” is sometimes used to mean different things. For clarity, as used herein, the term “checkpointing,” as in the phrase checkpointing an event count, is intended to mean that the event count is stored or otherwise preserved. Likewise, the “event counter checkpoint logic” is intended to mean that the logic is operable to store or otherwise preserve the event count. In other usages, such as in reference to speculative code execution, checkpointing refers a similar storing, maintain, tracking or preserving of an architecture state and/or memory state at a point in execution/time.

As shown, in one or more embodiments, the logic device may optionally have an event count storage location 328 to store an event count 330. In one or more embodiments, the event count storage location may include one or more special-purpose registers (e.g., one or more dedicated event counter registers) located on-die with the logic device. Alternatively, in one or more embodiments, the event count storage location may not be part of the logic device. For example, the event count storage location may be part of system memory.

An event count restore logic 332 is coupled with, or otherwise in communication with, the event counter. Also, in the particular illustrated embodiment, the event count restore logic is coupled with, or otherwise in communication with, the optional event count storage location.

The event count restore logic is operable to restore the event count 324 of the event counter 322 to the stored event count 330. In the illustration, the particular stored event count 330 is M. The illustration also shows an example of restoring the event count 324 of the event counter 322 from the value (M+N) back to the stored event count value of M. In this example, N may represent a count of events that occur in aborted and/or un-committed execution which are excluded from the final event count.

One area in which embodiments disclosed herein may find great utility is in the area of speculative execution. Speculative execution generally refers to the execution of code speculatively before being certain that the execution of this code should take place and/or is needed. Such speculative execution may be used to help improve performance and tends to be more useful when early execution consumes lesser resources than later execution would, and the savings are enough to compensate for the possible wasted resources if the execution was not needed. Performance tuning inside speculative regions tends to be challenging partly because it is difficult to distinguish event counts that occur during speculative regions that are not committed to final execution from events that occur during speculative regions that are committed to final execution. Speculative execution is used for various different purposes and in various different ways. As one example, speculative execution is often used with branch prediction. Similarly, speculative execution may be utilized in other execution techniques, such as lock elision and transactional memory, which are discussed in more detail below.

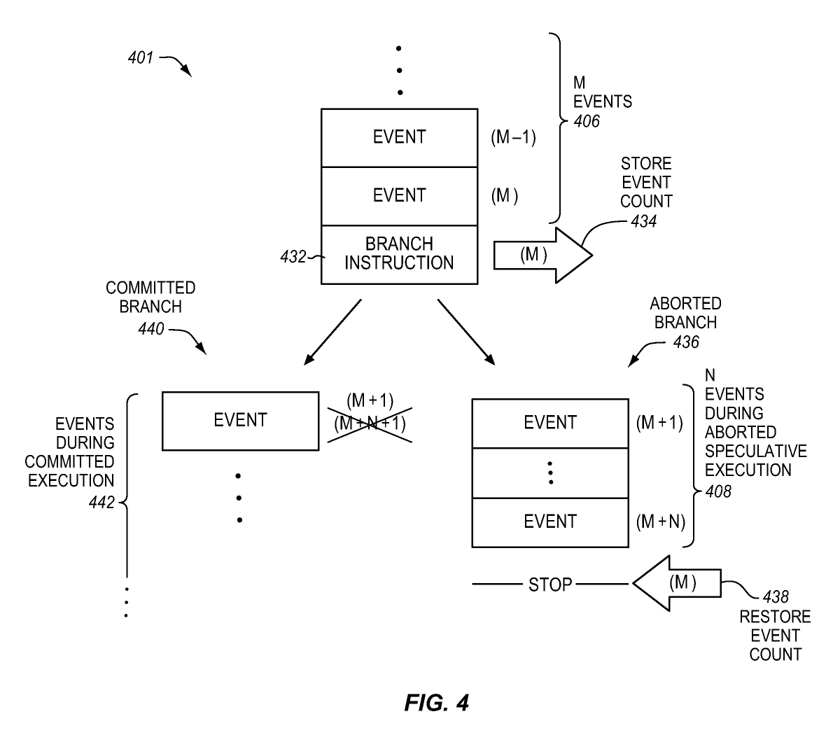

FIG. 4 is a block diagram illustrating an example embodiment 401 of counting events during speculative execution performed in conjunction with branch prediction. However, the illustrated embodiment, may similarly be applied to execution of a transaction (i.e. transactional memory) or for execution of a critical section (i.e. lock elision).

Initially, M events 406 may be counted by an event counter prior to a conditional branch instruction (or other control flow instruction) 432. The conditional branch instruction results in a branch in program flow. In the illustration two branches are shown.

When the conditional branch instruction is encountered, the logic device may not know which of the two branches is the correct branch to be taken. Instead, branch prediction may be used to predict which branch is the correct branch. Then speculative execution may be performed earlier assuming that the predicted branch is correct. If the predicted branch is later confirmed to be correct, then the speculative execution may be committed to final code flow. Otherwise, if the predicted branch is later determined to be incorrect, then the speculative execution of the incorrect branch may be aborted. All computation past the branch point may be discarded. This execution is un-committed execution that is not committed to final code flow. Execution may then be rolled back and the correct branch may be executed un-speculatively. Checkpointing may be used to record the architectural state prior to the speculative execution so that the architectural state may be rolled back to the state it was at prior to the speculative execution. Checkpointing is traditionally used for such fault tolerance, but as previously described event counters are not traditionally checkpointed. Such branch prediction and speculative execution is well known in the arts.

Referring again to the illustration, after encountering the branch instruction 432, and before counting events for the initially predicted branch, in accordance with one or more embodiments, the event count (M) of the event counter may be checkpointed or stored 434. In one or more embodiments, a conditional branch instruction, or other control flow instruction, may represent a trigger to cause the logic device to checkpoint the event counter.

Then, the branch 436 on the right-hand side (in this particular case), which is the initially predicted branch, may be executed speculatively. As shown, N additional events 4 may be counted by the event counter before the speculative execution is stopped (e.g., it is determined that this branch is incorrect). The speculative execution for this branch may be aborted and not committed to final code flow. As shown, the value of the event counter when the last event of this branch was counted may be (M+N).

After deciding to abort the initially predicted branch, and before counting events of the committed branch 440, in accordance with one or more embodiments, the previously stored event count (M) of the event counter may be restored 438. In one or more embodiments, a decision to abort a speculatively executed branch may represent a trigger to cause the logic device to restore the event counter to a stored event count. The stored event count (M) may then be discarded. The stored event count (M) may also be discarded if alternatively the speculative execution discussed above was committed instead of aborted. Without limitation, the program counter, registers, stacks, altered memory locations, as well as other parameters traditionally checkpointed during such speculative execution, may also be restored to their checkpointed values, although the scope of the invention is not limited in this regard.

Execution may then resume un-speculatively with the committed branch 440 on the left-hand side (in this particular case). The committed branch is now known to be the correct branch. The execution of the committed branch is committed to final code flow. As shown, the event counter, upon counting the first event of the committed branch, may have the event count (M+1), instead of (M+N+1), which would be the case if the N events counted during the aborted speculative execution were not excluded.

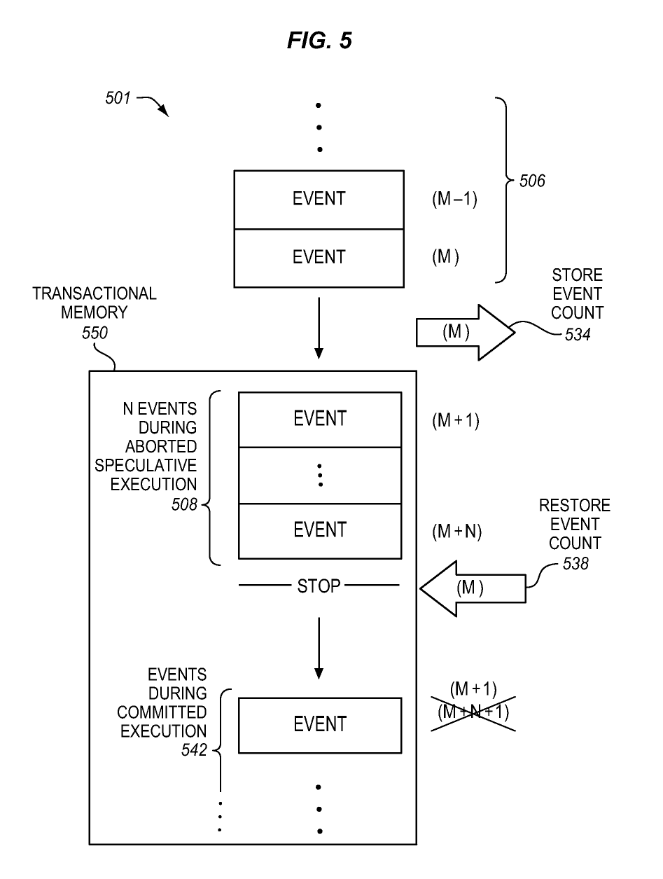

As another example, speculative execution is often performed in conjunction with transactional memory. FIG. 5 is a block diagram illustrating an example embodiment 501 of counting events during speculative execution performed in conjunction with execution in a transactional memory 550. However, the illustrative embodikment may similarly be applied to counting events during hardware lock elision (i.e. execution of a critical section like a transaction with elision of traditional lock store operations).

Initially, M events 506 may be counted by an event counter. The count (M) may represent a positive integer. Then a determination to perform transactional memory execution may be made.

Transactional memory execution is known in the arts. A detailed understanding of transactional memory execution is not needed to understand the present disclosure, although a brief overview may be helpful.

Some logic devices may execute multiple threads concurrently. Traditionally, before a thread accesses a shared resource, it may acquire a lock of the shared resource. In situations where the shared resource is a data structure stored in memory, all threads that are attempting to access the same resource may serialize the execution of their operations in light of mutual exclusivity provided by the locking mechanism. Additionally, there tends to be high communication overhead. This may be detrimental to system performance and/or in some cases may cause program failures, e.g., due to deadlock.

To reduce performance loss resulting from utilization of locking mechanisms, some logic devices may use transactional memory. Transactional memory generally refers to a synchronization model that may allow multiple threads to concurrently access a shared resource without utilizing a locking mechanism. Transactional memory may provide speculative lock elision. In transactional memory execution code may be executed speculatively within a transactional memory region without the lock. Checkpointing may be used to record the architectural state prior to the speculative execution so that the architectural state may be rolled back to the state it was at prior to the speculative execution if failure or abort occurs. If the speculative execution succeeds, the performance impact of locks may be elided. If the speculative execution is aborted, such as, for example, another component or process acquires the lock, the checkpointed architectural state may be restored. The code may then be executed un-speculatively in the transactional memory region.

Referring again to the illustration, after determining to perform transactional memory execution, and before counting events during the transactional memory execution, in accordance with one or more embodiments, the event count (M) of the event counter may be checkpointed or stored 534. In one or more embodiments, a determination to perform transactional memory execution, may represent a trigger to cause the logic device to checkpoint the event counter.

Then, the execution may be performed in the transactional memory speculatively. As shown, N additional events 508 may be counted by the event counter before the speculative execution in the transactional memory is stopped or aborted. The speculative transactional memory execution may not be committed to final code flow. As shown, the value of the event counter when the last event was counted may be (M+N).

After deciding to abort the speculative transactional memory execution, and before counting additional events, in accordance with one or more embodiments, the previously stored event count (M) of the event counter may be restored 538. In one or more embodiments, a decision to abort speculative transactional memory execution may represent a trigger to cause the logic device to restore the event counter to a stored event count. The stored event count (M) may then be discarded. The stored event count (M) may also be discarded if alternatively the speculative execution discussed above was committed instead of aborted. Without limitation, the program counter, registers, stacks, altered memory locations, as well as other parameters traditionally checkpointed during such speculative execution, may also be restored to their checkpointed values, although the scope of the invention is not limited in this regard.

Execution may then resume un-speculatively and one or more events may be counted during committed execution 542. As shown, the event counter, upon counting the first event, may have the event count (M+1), instead of (M+N+1), which would be the case if the N events counted during the aborted speculative transactional memory execution were not excluded.

Often in such speculative transactional memory execution, the number of instructions speculatively executed and aborted is not on the order of tens to hundreds of instructions, but generally tends to be larger, such as, for example, often ranging from tens to hundreds of thousands, or even millions. As a result, the events detected during the aborted and/or un-committed execution may represent a significant proportion of the total events. Advantageously, the embodiment of the event counter described, which is able to exclude events during aborted and/or un-committed execution and selectively count events during committed execution may help to improve understanding and/or performance of the logic device.

These aforementioned examples of speculative execution are only a few illustrative examples of ways in which speculative execution may be used. It is to be apprecitated that speculative execution may also be used in other ways.

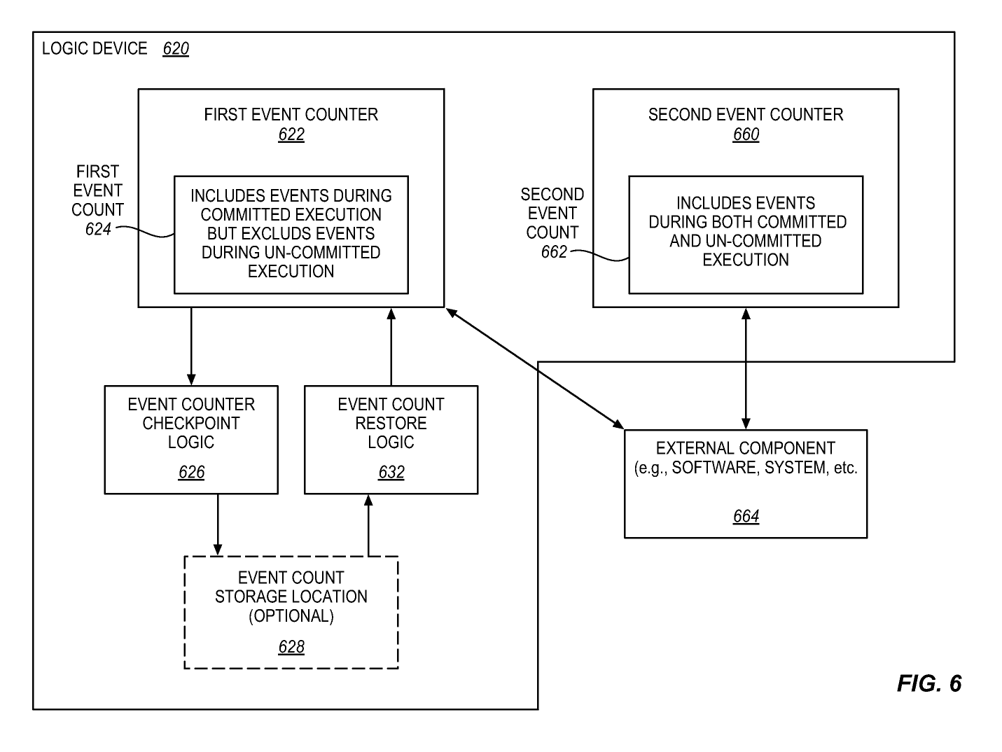

FIG. 6 is a block diagram of an embodiment of a logic device 620 having an embodiment of a first event counter 622 to exclude events during un-committed execution from an event count 624 and an embodiment of a second event counter 660 to include events counted during un-committed execution in an event count 662.

The logic device has the first event counter 622. The first event counter is operable to maintain a first event count 624. As shown, in one or more embodiments, the first event count 624 may include events counted during committed execution but may exclude events during un-committed execution. Such an event count is not available from single known event counters, and is not easily otherwise determined.

The logic device also has an event counter checkpoint logic 626, an optional event count storage location 628, and an event count restore logic 632. These components may optionally have some or all of the characteristics of the correspondingly named components of the logic device 320 of FIG. 3.

The logic device also has a second event counter 660. In alternate embodiments, there may be three, four, ten, or more event counters. Notice that the second event counter does not have in this embodiment, or at least does not utilize in this embodiment, event counter checkpoint logic and/or event count restore logic. That is, in one or more embodiments, at least one event counter is checkpointed and restored whereas at least one other event counter is not checkpointed and restored. The second event counter is operable to maintain a second event count 662. As shown, in one or more embodiments, the second event count 662 may include events counted during both committed execution and events counted during un-committed execution.

The first event count 624, and the second event count 662, represent different pieces of information about execution within the logic device. As previously mentioned, the first event count includes information that is not available from a single known event counter, and is not easily otherwise determined. It provides information about those events counted during committed execution while excluding events during un-committed execution. Additionally, the combination of the first and second event counts 624, 662 provides additional information. For example, subtracting the first event count 624 from the second event count 662 gives information about how many events were counted during un-committed or aborted execution. This may provide information about essentially wasted execution (e.g., aborted speculative execution due to mispredicted branches and/or aborted speculative execution due to aborted transactional memory execution).

However, utilizing two event counters in this manner to determine uncommitted events (i.e. events that occur in a speculative code region) and/or committed events (i.e. events that occur outside a speculative code region and/or those committed from a speculative code region is purely illustrative. As a first example, a single counter may be utilized to perform the same task. Here, counter 622 counts events (e.g. instruction retirement in this example) up until a speculative checkpoint region (e.g. X events). Then, the X event count is checkpointed in event checkpoint logic 626. And the counter continues to count instruction retirements in the speculative code region up until a commit or abort point. At a commit point, counter 622 has the current committed instruction retirement count—the number of instruction retirements before the speculative code region (X) and a number of instruction retirements counted during the speculative code region (Y) to equal a total of X+Y. And if a programmer or other wants to determine Y from the available information (counter 622 having a value of X+Y and checkpoint logic 626 having a checkpoint value of X, then Y is obtained by subtracting checkpoint value X from counter value X+Y). In contrast, if a rollback at an abort point in the speculative code region is required, then counter 626 is restored to checkpoint value X from checkpoint/store logic 626/628 with restore logic 632.

In another example, two counters may be utilized in yet a different manner. Here, counter 626 begins counting (as before) the events (e.g. instruction retirements). Upon encountering a speculative code region, counter 626 may continue or be stopped (based on designer choice). And a separate count (either by hardware or software), such as with second counter 660, starts counting the events at the start of the speculative code region (instead of second counter 660 counting the entire time as described above). As a result, in one embodiment, at the end of a speculative code region (either by abort or commit) counter 622 holds the total instruction retirement count—X+Y—(assuming counter 622 continued counting at the start of the speculative code region) and counter 660 holds the number of instruction retirements in the speculative code region. Consequently, no subtraction of counter 622 from 660 in the previously described embodiment is performed to obtain a number of uncommitted events (Y), as that count is already held in counter 660 in this embodiment. In other words, at the end of the speculative code region counter 660 holds event information for only the speculative code region; this may be directly extrapolated into performance related metrics to evaluate the efficacy of the speculative code region without having to perform the subtraction of the earlier described embodiment. However in this scenario, upon an abort, to obtain the “checkpoint” value (i.e. the value of counter 622 at the start of the speculative code region), then counter 660 is subtracted from counter 622—i.e. X+Y(622)—Y(660)=X(checkpoint value). In other words, in the earlier described embodiment a subtraction is performed to determine tracked uncommitted events, while in this embodiment the subtraction is performed to obtain the checkpoint value for restoration upon abort.

The event counts of committed and/or uncommitted sections of code may be used in different ways. In one or more embodiments, one or more of the first and second event counts may be used to tune or adjust the performance of the logic device. For example, in one or more embodiments, one or more of the first and second event counts may be used to tune or adjust speculative execution of the logic device. Tuning or adjusting the speculative execution may include tuning or adjusting a parameter, algorithm, or strategy. The tuning or adjusting may tune or adjust how aggressive the speculative execution is or choose whether speculation is to be performed. As one particular example, if the absolute difference between the first and second event counters (which provides information about events occurring during essentially wasted execution) is higher than average, higher than a threshold, higher than desired, or otherwise considered high, then speculative execution may be decreased, throttled back, turned off, or otherwise tuned or adjusted. Depending upon the implementation, this may be desired in order to reduce heat generation, conserve battery power or other limited power supply, or for other reasons. One or more of the first and second event counts may also or alternatively be used to analyze, optimize, and/or debug code. For example, information about wasted speculative execution may help to allow better branch prediction algorithms to be developed or selected for certain types of processing.

In one or more embodiments, the logic device 620 may include additional logic (not shown) to use one or more of the first and second event counts 624, 662 in any of these various different ways. For example, in one or more embodiments, the logic device may include performance tuning logic and/or speculative execution tuning logic.

In one or more embodiments, an external component 664, which is external to the logic device, may access and/or receive one or more of the first and second event counts 624, 662. In one or more embodiments, the external component may include software. In one aspect, the software may include an operating system or operating system component. In another aspect, the software may include a performance tuning application, which may include processor microcode, privileged level software, and/or user-level software. In yet another aspect, the software may include a debugger. By way of example, in one or more embodiments, the first and/or the second event counts may be stored in a register or other storage location that may be read, for example, with a machine instruction. In one or more embodiments, the first and/or the second event counts may be used to optimize or at least improve the code so that it executes better (e.g., there is less aborted code). For example, if a specific critical section is determined to be too high of a cost to be aborted (as indicated by the difference in counters read by software), then a dynamic compiler recompiles the critical section of code and removes an XAQCUIRE prefix and XRELEASE prefix (described in more detail below) to return the critical section to a traditional non-speculative, mutual exclusion locking section of code. Performance monitoring counters are often used to improve code in this way.

In one or more embodiments, the external component 664 may include hardware. In one aspect, the hardware may include a system (e.g., a computer system, embedded device, network appliance, router, switch, etc.). By way of example, in one or more embodiments, the first and/or the second event counts may be provided as output on a pin or other interface.

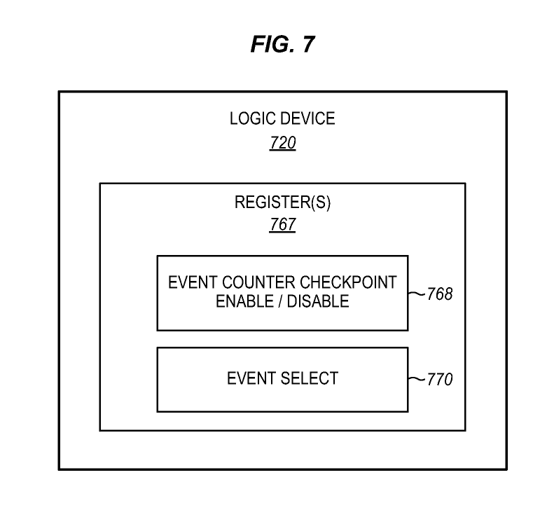

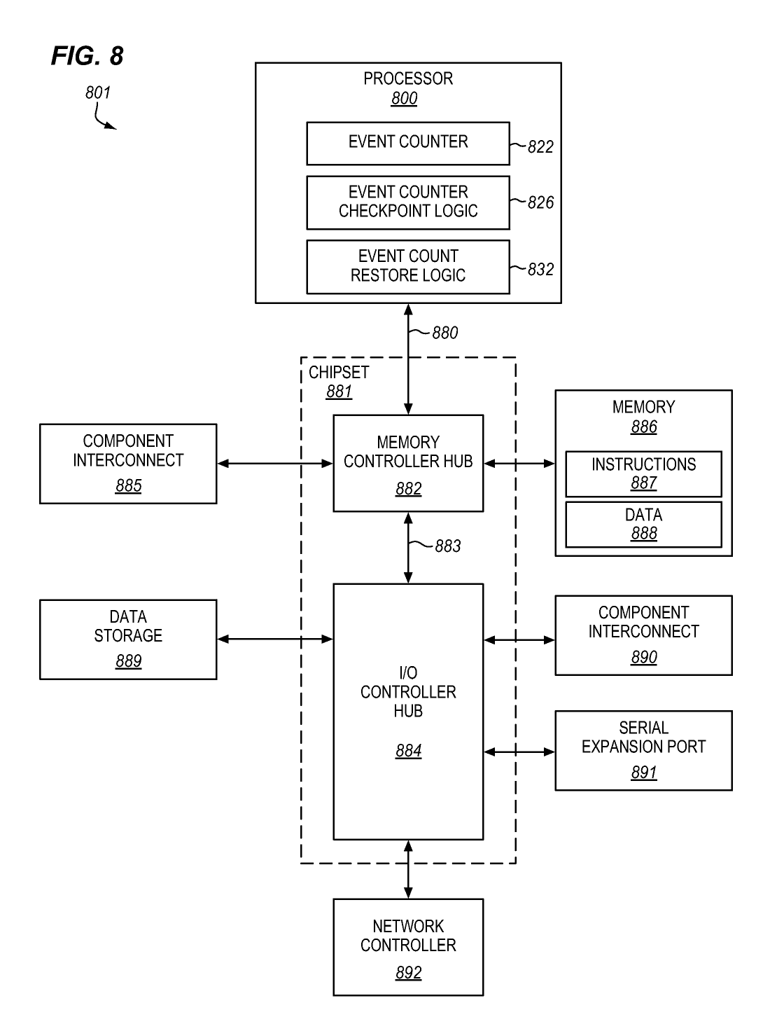

FIG. 7 is a block diagram of an embodiment of a configurable logic device 720. The configurable logic device has one or more control and/or configuration registers 767.

In this embodiment, at least one event counter is capable of being enabled or disabled by a user (e.g. user level software), application, privileged level software, Operating System, Hypervisor, microcode, compiler, or combination thereof for checkpoint and restore. The one or more registers have an event counter checkpoint enable/disable 768 for the at least one event counter. For example, in one particular embodiment, a single bit (or multiple bits) in a register corresponding to a particular event counter may be set to a value of one (or any enable value) to enable event counter checkpointing and restoring as disclosed herein to be performed for that event counter. If desired, a plurality or each event counter may similarly have one or more corresponding bits in one or more corresponding registers to enable or disable event counter checkpointing and restoring for each corresponding event counter. In one or more embodiments, additional bits may be provided for each event counter to specify various different types of event counter checkpointing and restoring, such as, for example, if the checkpointing and restoring is to be performed for aborted speculative execution or some other form of execution to differentiate with respect to.

In this embodiment, at least one event counter is a programmable event counter. The one or more registers have an event select 770 for the at least one programmable event counter. For example, in one particular embodiment, a plurality of bits (e.g., eight bits or sixteen bits, or some other number of bits) may represent a code that encodes a particular type of event to count (e.g. any of the events described above). If desired, a plurality or each event counter may similarly have a plurality of corresponding bits in one or more corresponding registers to allow event selection for each of the event counters. In one aspect, depending upon the implementation, anywhere from tens to hundreds of different types of events may selected for counting. Alternatively, rather than programmable event counters, fixed event counters that always count the same thing may optionally be used.

Still other embodiments pertain to a computer system, or other electronic device having an event counter and logic and/or performing a method as disclosed herein.

FIG. 8 is a block diagram of a first example embodiment of a suitable computer system 801. The computer system includes a processor 800. The processor includes an event counter 822, event counter checkpoint logic 826, and event count restore logic 832. These may be as previously described. In one or more embodiments, the processor may be an out-of-order microprocessor that supports speculative execution. In one or more embodiments, the processor may support speculative execution in transactional memory.

The processor is coupled to a chipset 881 via a bus (e.g., a front side bus) or other interconnect 880. The interconnect may be used to transmit data signals between the processor and other components in the system via the chipset.

The chipset includes a system logic chip known as a memory controller hub (MCH) 882. The MCH is coupled to the front side bus or other interconnect 880.

A memory 886 is coupled to the MCH. In various embodiments, the memory may include a random access memory (RAM). DRAM is an example of a type of RAM used in some but not all computer systems. As shown, the memory may be used to store instructions 887 and data 888.

A component interconnect 885 is also coupled with the MCH. In one or more embodiments, the component interconnect may include one or more peripheral component interconnect express (PCIe) interfaces. The component interconnect may allow other components to be coupled to the rest of the system through the chipset. One example of such components is a graphics chip or other graphics device, although this is optional and not required.

The chipset also includes an input/output (I/O) controller hub (ICH) 884. The ICH is coupled to the MCH through hub interface bus or other interconnect 883. In one or more embodiments, the bus or other interconnect 883 may include a Direct Media Interface (DMI).

A data storage 889 is coupled to the ICH. In various embodiments, the data storage may include a hard disk drive, a floppy disk drive, a CD-ROM device, a flash memory device, or the like, or a combination thereof.

A second component interconnect 890 is also coupled with the ICH. In one or more embodiments, the second component interconnect may include one or more peripheral component interconnect express (PCIe) interfaces. The second component interconnect may allow various types of components to be coupled to the rest of the system through the chipset.

A serial expansion port 891 is also coupled with the ICH. In one or more embodiments, the serial expansion port may include one or more universal serial bus (USB) ports. The serial expansion port may allow various other types of input/output devices to be coupled to the rest of the system through the chipset.

A few illustrative examples of other components that may optionally be coupled with the ICH include, but are not limited to, an audio controller, a wireless transceiver, and a user input device (e.g., a keyboard, mouse).

A network controller is also coupled to the ICH. The network controller may allow the system to be coupled with a network.

In one or more embodiments, the computer system may execute a version of the WINDOWS™ operating system, available from Microsoft Corporation of Redmond, Washington. Alternatively, other operating systems, such as, for example, UNIX, Linux, or embedded systems, may be used.

This is just one particular example of a suitable computer system. For example, in one or more alternate embodiments, the processor may have multiple cores. As another example, in one or more alternate embodiments, the MCH 882 may be physically integrated on-die with the processor 800 and the processor may be directly coupled with a memory 886 through the integrated MCH. As a further example, in one or more alternate embodiments, other components may be integrated on-die with the processor, such as to provide a system-on-chip (SoC) design. As yet another example, in one or more alternate embodiments, the computer system may have multiple processors.

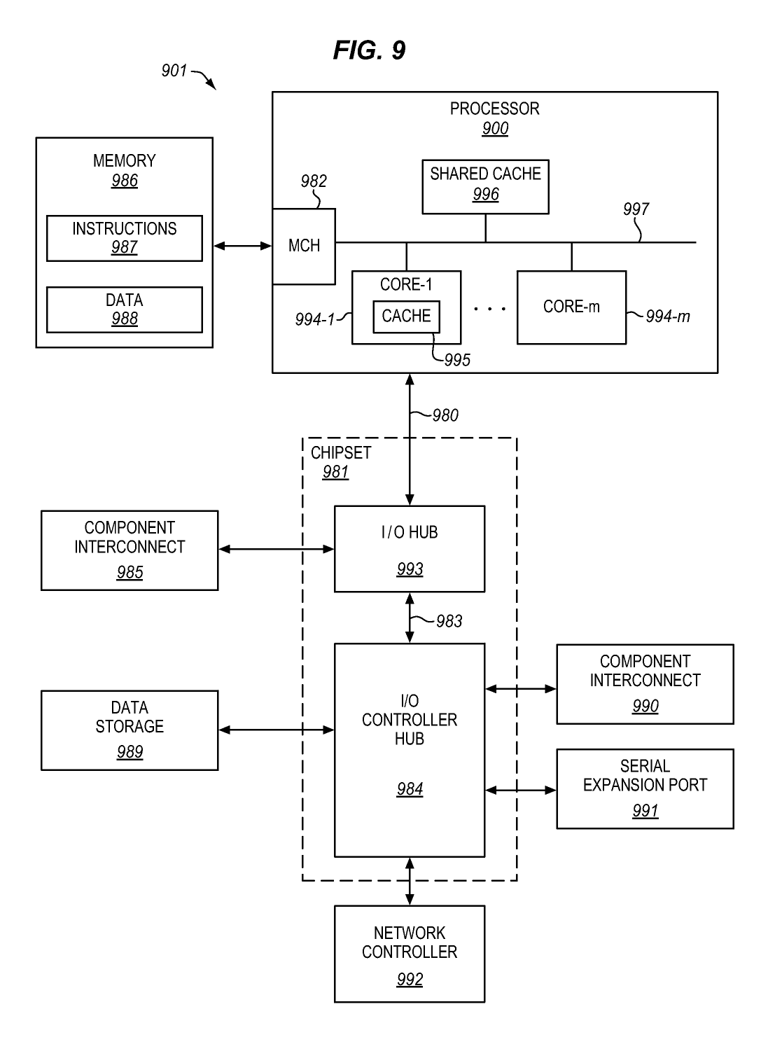

FIG. 9 is a block diagram of a second example embodiment of a suitable computer system 901. The second example embodiment has certain similarities to the first example computer system described immediate above. For clarity, the discussion will tend to emphasize the differences without repeating all of the similarities.

Similar to the first example embodiment described above, the computer system includes a processor 900, and a chipset 981 having an I/O controller hub (ICH) 984. Also similarly to the first example embodiment, the computer system includes a first component interconnect 985 coupled with the chipset, a second component interconnect 990 coupled with the ICH, a serial expansion port 991 coupled with the ICH, a network controller 992 coupled with the ICH, and a data storage 989 coupled with the ICH.

In this second embodiment, the processor 900 is a multi-core processor. The multi-core processor includes processor cores 994-1 through 994-M, where M may be an integer number equal to or larger than two (e.g. two, four, seven, or more). As shown, the core-1 includes a cache 995 (e.g., an L1 cache). Each of the other cores may similarly include a dedicated cache. The processor cores may be implemented on a single integrated circuit (IC) chip.

In one or more embodiments, at least one, or a plurality or all of the cores may have an event counter, an event counter checkpoint logic, and event count restore logic, as described elsewhere herein. Such logic may additionally, or alternatively, be included outside of a core.

The processor also includes at least one shared cache 996. The shared cache may store data and/or instructions that are utilized by one or more components of the processor, such as the cores. For example, the shared cache may locally cache data stored in a memory 986 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

The processor cores and the shared cache are each coupled with a bus or other interconnect 997. The bus or other interconnect may couple the cores and the shared cache and allow communication.

The processor also includes a memory controller hub (MCH) 982. As shown in this example embodiment, the MCH is integrated with the processor 900. For example, the MCH may be on-die with the processor cores. The processor is coupled with the memory 986 through the MCH. In one or more embodiments, the memory may include DRAM, although this is not required.

The chipset includes an input/output (I/O) hub 993. The I/O hub is coupled with the processor through a bus (e.g., a QuickPath Interconnect (QPI)) or other interconnect 980. The first component interconnect 985 is coupled with the I/O hub 993.

This is just one particular example of a suitable system. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or an execution unit as disclosed herein are generally suitable.

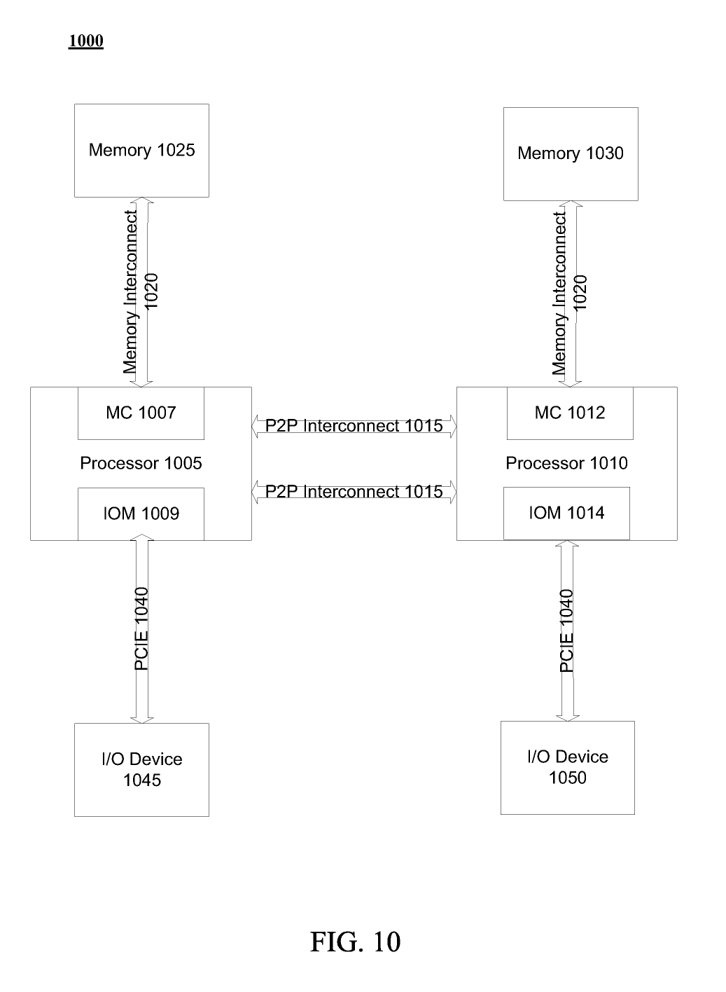

Referring to FIGS. 10-12, other embodiments of a computer system configurations adapted to include processors that are to provide performance counter speculative control are illustrated. In reference to FIG. 10, an illustrative example of a two processor system 1000 with an integrated memory controller and Input/Output (I/O) controller in each processor 1005, 1010 is depicted. Although not discussed in detail to avoid obscuring the discussion, platform 1000 illustrates multiple interconnects to transfer information between components. For example, point-to-point (P2P) interconnect 1015, in one embodiment, includes a serial P2P, bi-directional, cache coherent bus with a layered protocol architecture that enables high-speed data transfer. Moreover, a commonly known interface (Peripheral Component Interconnect Express, PCIE) or variant thereof is utilized for interface 1040 between I/O devices 1045, 1050. However, any known interconnect or interface may be utilized to communicate to or within domains of a computing system.

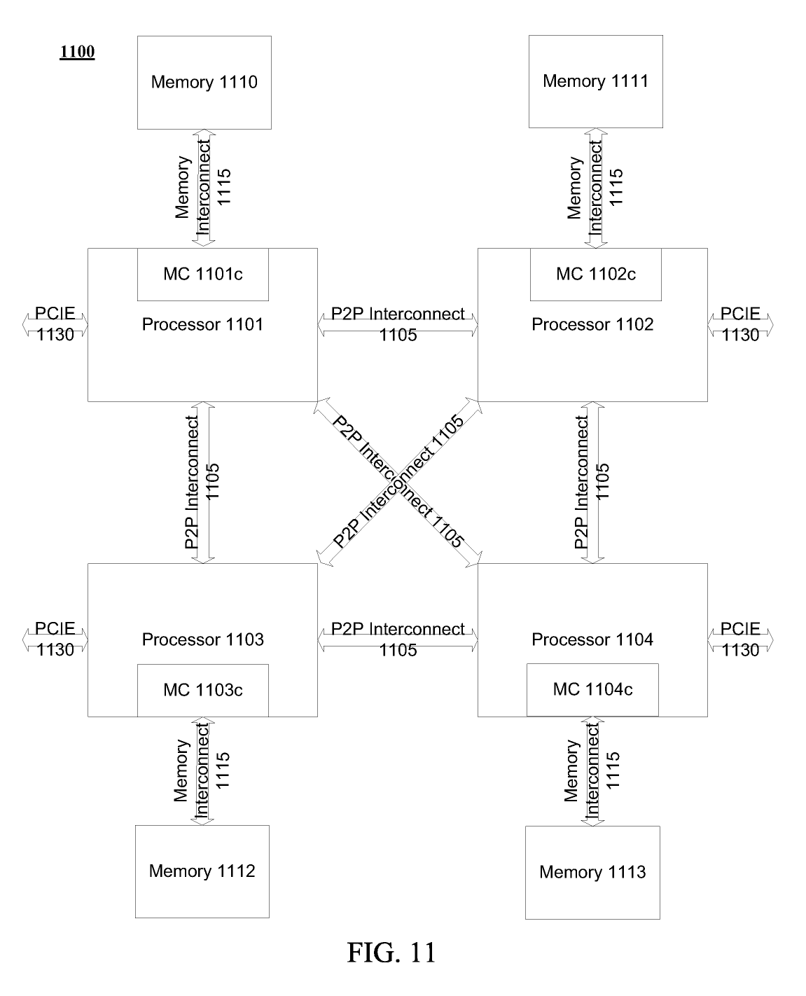

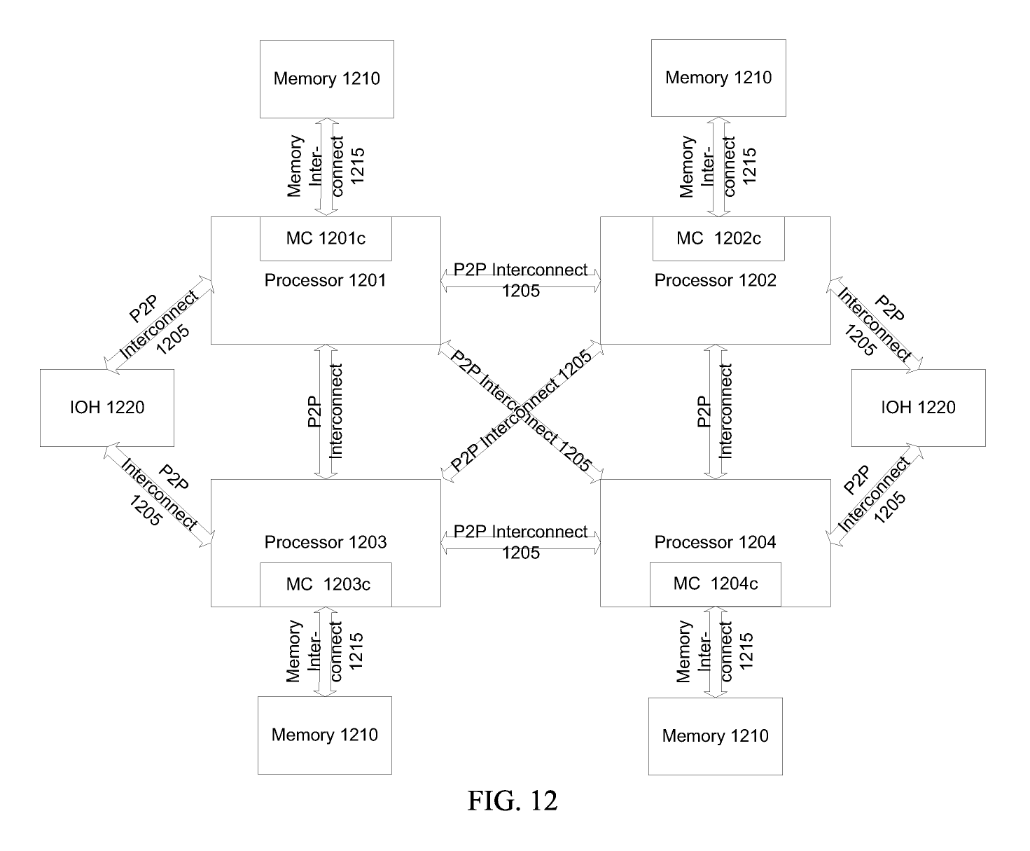

Turning to FIG. 11 a quad processor platform 1100 is illustrated. As in FIG. 10, processors 1101-1104 are coupled to each other through a high-speed P2P interconnect 1105. And processors 1101-1104 include integrated controllers 1101c-1104c. FIG. 12 depicts another quad core processor platform 1200 with a different configuration. Here, instead of utilizing an on-processor I/O controller to communicate with I/O devices over an I/O interface, such as a PCI-E interface, the P2P interconnect is utilized to couple the processors and I/O controller hubs 1220. Hubs 1220 then in turn communicate with I/O devices over a PCIE-like interface.

Referring to FIG. 13, an embodiment of a processor including multiple cores is illustrated. Processor 1300 includes any processor or processing device, such as a microprocessor, an embedded processor, a digital signal processor (DSP), a network processor, a handheld processor, an application processor, a co-pocessor, or other device to execute code. Processor 1300, in one embodiment, includes at least two cores—core 1301 and 1302, which may include asymmetric cores or symmetric cores (the illustrated embodiment). However, processor 1300 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 1300, as illustrated in FIG. 13, includes two cores, core 1301 and 1302. Here, core 1301 and 1302 are considered symmetric cores, i.e. cores with the same configurations, functional units, and/or logic. In another embodiment, core 1301 includes an out-of-order processor core, while core 1302 includes an in-order processor core. However, cores 1301 and 1302 may be individually selected from any type of core, such as a native core, a software managed core, a core adapted to execute a native Instruction Set Architecture (ISA), a core adapted to execute a translated Instruction Set Architecture (ISA), a co-designed core, or other known core. Yet to further the discussion, the functional units illustrated in core 1301 are described in further detail below, as the units in core 1302 operate in a similar manner.

As depicted, core 1301 includes two hardware threads 1301a and 1301b, which may also be referred to as hardware thread slots 1301a and 1301b. Therefore, software entities, such as an operating system, in one embodiment potentially view processor 1300 as four separate processors, i.e. four logical processors or processing elements capable of executing four software threads concurrently. As eluded to above, a first thread is associated with architecture state registers 1301a, a second thread is associated with architecture state registers 1301b, a third thread may be associated with architecture state registers 1302a, and a fourth thread may be associated with architecture state registers 1302b. Here, each of the architecture state registers (1301a, 1301b, 1302a, and 1302b) may be referred to as processing elements, thread slots, or thread units, as described above. As illustrated, architecture state registers 1301a are replicated in architecture state registers 130 lb, so individual architecture states/contexts are capable of being stored for logical processor 1301a and logical processor 1301b. In core 1301, other smaller resources, such as instruction pointers and renaming logic in rename allocater logic 1330 may also be replicated for threads 1301a and 1301b. Some resources, such as re-order buffers in reorder/retirement unit 1335, ILTB 1320, load/store buffers, and queues may be shared through partitioning. Other resources, such as general purpose internal registers, page-table base register(s), low-level data-cache and data-TLB 1315, execution unit(s) 1340, and portions of out-of-order unit 1335 are potentially fully shared.

Processor 1300 often includes other resources, which may be fully shared, shared through partitioning, or dedicated by/to processing elements. In FIG. 13, an embodiment of a purely exemplary processor with illustrative logical units/resources of a processor is illustrated. Note that a processor may include, or omit, any of these functional units, as well as include any other known functional units, logic, or firmware not depicted. As illustrated, core 1301 includes a simplified, representative out-of-order (000) processor core. But an in-order processor may be utilized in different embodiments. The 000 core includes a branch target buffer 1320 to predict branches to be executed/taken and an instruction-translation buffer (I-TLB) 1320 to store address translation entries for instructions.

Core 1301 further includes decode module 1325 coupled to fetch unit 1320 to decode fetched elements. Fetch logic, in one embodiment, includes individual sequencers associated with thread slots 1301a, 1301b, respectively. Usually core 1301 is associated with a first Instruction Set Architecture (ISA), which defines/specifies instructions executable on processor 1300. Often machine code instructions that are part of the first ISA include a portion of the instruction (referred to as an opcode), which references/specifies an instruction or operation to be performed. Decode logic 1325 includes circuitry that recognizes these instructions from their opcodes and passes the decoded instructions on in the pipeline for processing as defined by the first ISA. For example, as discussed in more detail below decoders 1325, in one embodiment, include logic designed or adapted to recognize specific instructions, such as transactional instructions or non-transactional instructions for execution within a critical section or transactional region. As a result of the recognition by decoders 1325, the architecture or core 1301 takes specific, predefined actions to perform tasks associated with the appropriate instruction. It is important to note that any of the tasks, blocks, operations, and methods described herein may be performed in response to a single or multiple instructions; some of which may be new or old instructions.

In one example, allocator and renamer block 1330 includes an allocator to reserve resources, such as register files to store instruction processing results. However, threads 1301a and 1301b are potentially capable of out-of-order execution, where allocator and renamer block 1330 also reserves other resources, such as reorder buffers to track instruction results. Unit 1330 may also include a register renamer to rename program/instruction reference registers to other registers internal to processor 1300. Reorder/retirement unit 1335 includes components, such as the reorder buffers mentioned above, load buffers, and store buffers, to support out-of-order execution and later in-order retirement of instructions executed out-of-order.

Scheduler and execution unit(s) block 1340, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 1350 are coupled to execution unit(s) 1340. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 1301 and 1302 share access to higher-level or further-out cache 1310, which is to cache recently fetched elements. Note that higher-level or further-out refers to cache levels increasing or getting further way from the execution unit(s). In one embodiment, higher-level cache 1310 is a last-level data cache—last cache in the memory hierarchy on processor 1300—such as a second or third level data cache. However, higher level cache 1310 is not so limited, as it may be associated with or include an instruction cache. A trace cache—a type of instruction cache—instead may be coupled after decoder 1325 to store recently decoded instruction traces.

In the depicted configuration, processor 1300 also includes bus interface module 1305. Historically, controller 1370, which is described in more detail below, has been included in a computing system external to processor 1300. In this scenario, bus interface 1305 is to communicate with devices external to processor 1300, such as system memory 1375, a chipset (often including a memory controller hub to connect to memory 1375 and an I/O controller hub to connect peripheral devices), a memory controller hub, a northbridge, or other integrated circuit. And in this exemplary configuration, bus 1305 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Note however, that in the depicted embodiment, the controller 1370 is illustrated as part of processor 1300. Recently, as more logic and devices are being integrated on a single die, such as System on a Chip (SOC), each of these devices may be incorporated on processor 1300. For example in one embodiment, memory controller hub 1370 is on the same package and/or die with processor 1300. Here, a portion of the core (an on-core portion) includes one or more controller(s) 1370 for interfacing with other devices such as memory 1375 or a graphics device 1380. The configuration including an interconnect and/or controllers for interfacing with such devices is often referred to as an on-core (or un-core configuration). As an example, bus interface 1305 includes a ring interconnect with a memory controller for interfacing with memory 1375 and a graphics controller for interfacing with graphics processor 1380. Yet, in the SOC environment, even more devices, such as the network interface, co-processors, memory 1375, graphics processor 1380, and any other known computer devices/interface may be integrated on a single die or integrated circuit to provide small form factor with high functionality and low power consumption.

In one embodiment, processor 1300 is capable of hardware transactional execution, software transactional execution, or a combination/hybrid thereof. A transaction, which may also be referred to as execution of an atomic section/region of code, includes a grouping of instructions or operations to be executed as an atomic group. For example, instructions or operations may be used to demarcate or delimit a transaction or a critical section. In one embodiment, which is described in more detail below, these instructions are part of a set of instructions, such as an Instruction Set Architecture (ISA), which are recognizable by hardware of processor 1300, such as decoder(s) 1325 described above. Often, these instructions, once compiled from a high-level language to hardware recognizable assembly language include operation codes (opcodes), or other portions of the instructions, that decoder(s) 1325 recognize during a decode stage. Transactional execution may be referred to herein as explicit (transactional memory via new instructions) or implicit (speculative lock elision via eliding of lock instructions, which is potentially based on hint versions of lock instructions).

Typically, during execution of a transaction, updates to memory are not made globally visible until the transaction is committed. As an example, a transactional write to a location is potentially visible to a local thread; yet, in response to a read from another thread the write data is not forwarded until the transaction including the transactional write is committed. While the transaction is still pending, data items/elements loaded from and written to within a memory are tracked, as discussed in more detail below. Once the transaction reaches a commit point, if conflicts have not been detected for the transaction, then the transaction is committed and updates made during the transaction are made globally visible. However, if the transaction is invalidated during its pendency, the transaction is aborted and potentially restarted without making the updates globally visible. As a result, pendency of a transaction, as used herein, refers to a transaction that has begun execution and has not been committed or aborted (i.e. pending).

A Software Transactional Memory (STM) system often refers to performing access tracking, conflict resolution, or other transactional memory tasks within or at least primarily through execution of software or code. In one embodiment, processor 1300 is capable of executing transactions utilizing hardware/logic, i.e. within a Hardware Transactional Memory (HTM) system, which is also referred to as a Restricted Transactional Memory (RTM) since it is restricted to the available hardware resources. Numerous specific implementation details exist both from an architectural and microarchitectural perspective when implementing an HTM; most of which are not discussed herein to avoid unnecessarily obscuring the discussion. However, some structures, resources, and implementations are disclosed for illustrative purposes. Yet, it should be noted that these structures and implementations are not required and may be augmented and/or replaced with other structures having different implementation details.

Another execution technique closely related to transactional memory includes lock elision I often referred to as speculative lock elision (SLE) or hardware lock elision (HLE)}. In this scenario, lock instruction pairs (lock and lock release) are augmented/replaced (either by a user, software, or hardware) to indicate atomic a start and an end of a critical section. And the critical section is executed in a similar manner to a transaction (i.e. tentative results are not made globally visible until the end of the critical section). Note that the discussion immediately below returns generally to transactional memory; however, the description may similarly apply to SLE, which is described in more detail later.

As a combination, processor 1300 may be capable of executing transactions using a hybrid approach (both hardware and software), such as within an unbounded transactional memory (UTM) system, which attempts to take advantage of the benefits of both STM and HTM systems. For example, an HTM is often fast and efficient for executing small transactions, because it does not rely on software to perform all of the access tracking, conflict detection, validation, and commit for transactions. However, HTMs are usually only able to handle smaller transactions, while STMs are able to handle larger size transactions, which are often referred to as unbounded sized transactions. Therefore, in one embodiment, a UTM system utilizes hardware to execute smaller transactions and software to execute transactions that are too big for the hardware. As can be seen from the discussion below, even when software is handling transactions, hardware may be utilized to assist and accelerate the software; this hybrid approach is commonly referred to as a hardware accelerated STM, since the primary transactional memory system (bookkeeping, etc) resides in software but is accelerated using hardware hooks.

Returning the discussion to FIG. 13, in one embodiment, processor 1300 includes monitors to detect or track accesses, and potential subsequent conflicts, associated with data items; these may be utilized in hardware transactional execution, lock elision, acceleration of a software transactional memory system, or a combination thereof. A data item, data object, or data element may include data at any granularity level, as defined by hardware, software or a combination thereof. A non-exhaustive list of examples of data, data elements, data items, or references thereto, include a memory address, a data object, a class, a field of a type of dynamic language code, a type of dynamic language code, a variable, an operand, a data structure, and an indirect reference to a memory address. However, any known grouping of data may be referred to as a data element or data item. A few of the examples above, such as a field of a type of dynamic language code and a type of dynamic language code refer to data structures of dynamic language code. To illustrate, dynamic language code, such as Java™ from Sun Microsystems, Inc, is a strongly typed language. Each variable has a type that is known at compile time. The types are divided in two categories—primitive types (boolean and numeric, e.g., int, float) and reference types (classes, interfaces and arrays). The values of reference types are references to objects. In Java™, an object, which consists of fields, may be a class instance or an array. Given object a of class A it is customary to use the notation A::x to refer to the field x of type A and a.x to the field x of object a of class A. For example, an expression may be couched as a.x=a.y+a.z. Here, field y and field z are loaded to be added and the result is to be written to field x.

Therefore, monitoring/buffering memory accesses to data items may be performed at any of data level granularity. For example in one embodiment, memory accesses to data are monitored at a type level. Here, a transactional write to a field A::x and a non-transactional load of field A::y may be monitored as accesses to the same data item, i.e. type A. In another embodiment, memory access monitoring/buffering is performed at a field level granularity. Here, a transactional write to A::x and a non-transactional load of A::y are not monitored as accesses to the same data item, as they are references to separate fields. Note, other data structures or programming techniques may be taken into account in tracking memory accesses to data items. As an example, assume that fields x and y of object of class A (i.e. A::x and A::y) point to objects of class B, are initialized to newly allocated objects, and are never written to after initialization. In one embodiment, a transactional write to a field B::z of an object pointed to by A::x are not monitored as memory access to the same data item in regards to a non-transactional load of field B::z of an object pointed to by A::y. Extrapolating from these examples, it is possible to determine that monitors may perform monitoring/buffering at any data granularity level.

Note these monitors, in one embodiment, are the same attributes (or included with) the attributes described above. Monitors may be utilized purely for tracking and conflict detection purposes. Or in another scenario, monitors double as hardware tracking and software acceleration support. Hardware of processor 1300, in one embodiment, includes read monitors and write monitors to track loads and stores, which are determined to be monitored, accordingly (i.e. track tentative accesses from a transaction region or critical section). Hardware read monitors and write monitors may monitor data items at a granularity of the data items despite the granularity of underlying storage structures. Or alternatively, they monitor at the storage structure granularity. In one embodiment, a data item is bounded by tracking mechanisms associated at the granularity of the storage structures to ensure the at least the entire data item is monitored appropriately. As an illustrative example, if a data object spans 1.5 cache lines, the monitors for each of the two cache lines are set to ensure that the entire data object is appropriately tracked even though the second cache line is not full with tentative data.

In one embodiment, read and write monitors include attributes associated with cache locations, such as locations within lower level data cache 1350, to monitor loads from and stores to addresses associated with those locations. Here, a read attribute for a cache location of data cache 1350 is set upon a read event to an address associated with the cache location to monitor for potential conflicting writes to the same address. In this case, write attributes operate in a similar manner for write events to monitor for potential conflicting reads and writes to the same address. To further this example, hardware is capable of detecting conflicts based on snoops for reads and writes to cache locations with read and/or write attributes set to indicate the cache locations are monitored. Inversely, setting read and write monitors, or updating a cache location to a buffered state, in one embodiment, results in snoops, such as read requests or read for ownership requests, which allow for conflicts with addresses monitored in other caches to be detected.

Therefore, based on the design, different combinations of cache coherency requests and monitored coherency states of cache lines result in potential conflicts, such as a cache line holding a data item in a shared, read monitored state and an external snoop indicating a write request to the data item. Inversely, a cache line holding a data item being in a buffered write state and an external snoop indicating a read request to the data item may be considered potentially conflicting. In one embodiment, to detect such combinations of access requests and attribute states, snoop logic is coupled to conflict detection/reporting logic, such as monitors and/or logic for conflict detection/reporting, as well as status registers to report the conflicts.

However, any combination of conditions and scenarios may be considered invalidating for a transaction or critical section. Examples of factors, which may be considered for non-commit of a transaction, includes detecting a conflict to a transactionally accessed memory location, losing monitor information, losing buffered data, losing metadata associated with a transactionally accessed data item, and detecting an other invalidating event, such as an interrupt, ring transition, or an explicit user instruction.

In one embodiment, hardware of processor 1300 is to hold transactional updates in a buffered manner. As stated above, transactional writes are not made globally visible until commit of a transaction. However, a local software thread associated with the transactional writes is capable of accessing the transactional updates for subsequent transactional accesses. As a first example, a separate buffer structure is provided in processor 1300 to hold the buffered updates, which is capable of providing the updates to the local thread and not to other external threads.

In contrast, as another example, a cache memory (e.g. data cache 1350) is utilized to buffer the updates, while providing the same transactional or lock elision buffering functionality. Here, cache 1350 is capable of holding data items in a buffered coherency state, which may include a full new coherency state or a typical coherency state with a write monitor set to indicate the associated line holds tentative write information. In the first case, a new buffered coherency state is added to a cache coherency protocol, such as a Modified Exclusive Shared Invalid (MESI) protocol to form a MESIB protocol. In response to local requests for a buffered data item—data item being held in a buffered coherency state, cache 1350 provides the data item to the local processing element to ensure internal transactional sequential ordering. However, in response to external access requests, a miss response is provided to ensure the transactionally updated data item is not made globally visible until commit. Furthermore, when a line of cache 1350 is held in a buffered coherency state and selected for eviction, the buffered update is not written back to higher level cache memories—the buffered update is not to be proliferated through the memory system (i.e. not made globally visible, until after commit). Instead, the transaction may abort or the evicted line may be stored in a speculative structure between the data cache and the higher level cache memories, such as a victim cache. Upon commit, the buffered lines are transitioned to a modified state to make the data item globally visible. Note the same action/responses, in another embodiment, are taken when a normal MESI protocol is utilized in conjunction with read/write monitors, instead of explicitly providing a new cache coherency state in a cache state array; this is potentially useful when monitors/attributes are included elsewhere (i.e. not implemented in cache 1350's state array). But the actions of control logic in regards to local and global observability remain relatively the same.

Note that the terms internal and external are often relative to a perspective of a thread associated with execution of a transaction/critical section or processing elements that share a cache. For example, a first processing element for executing a software thread associated with execution of a transaction or a critical section is referred to a local thread. Therefore, in the discussion above, if a store to or load from an address previously written by the first thread, which results in a cache line for the address being held in a buffered coherency state (or a coherency state associated with a read or write monitor state), is received; then the buffered version of the cache line is provided to the first thread since it is the local thread. In contrast, a second thread may be executing on another processing element within the same processor, but is not associated with execution of the transaction responsible for the cache line being held in the buffered state—an external thread; therefore, a load or store from the second thread to the address misses the buffered version of the cache line and normal cache replacement is utilized to retrieve the unbuffered version of the cache line from higher level memory. In one scenario, this eviction may result in an abort (or at least a conflict between threads that is to be resolved in some fashion). Note from this discussion that reference below to a ‘processor’ in a transactional (or HLE) mode may refer to the entire processor or only a processing element thereof that is to execute (or be associated with execution of) a transaction/critical section.

Although much of the discussion above has been focused on transactional execution, hardware or speculative lock elision (HLE or SLE) may be similarly utilized. As mentioned above, critical sections are demarcated or defined by a programmer's use of lock instructions and subsequent lock release instructions. Or in another scenario, a user is capable of utilizing begin and end critical section instructions (e.g. lock and lock release instructions with associated begin and end hints to demarcate/define the critical sections). In one embodiment, explicit lock or lock release instructions are utilized. For example, in Intel®'s current IA-32 and Intel®® 64 instruction set an Assert Lock# Signal Prefix, which has opcode FO, may be pre-pended to some instructions to ensure exclusive access of a processor to a shared memory. Here, a programmer, compiler, optimizer, translator, firmware, hardware, or combination thereof utilizes one of the explicit lock instructions in combination with a predefined prefix hint to indicate the lock instruction is hinting a beginning of a critical section.

However, programmers may also utilize address locations as metadata or locks for locations as a construct of software. For example, a programmer using a first address location as a lock/meta-data for a first hash table sets the value at the first address location to a first logical state, such as zero, to represent that the hash table may be accessed, i.e. unlocked. Upon a thread of execution entering the hash table, the value at the first address location will be set to a second logical value, such as a one, to represent that the first hash table is locked. Consequently, if another thread wishes to access the hash table, it previously would wait until the lock is reset by the first thread to zero. As a simplified illustrative example of an abstracted lock, a conditional statement is used to allow access by a thread to a section of code or locations in memory, such as if lock_variable is the same as 0, then set the lock_variable to 1 and access locations within the hash table associated with the lock_variable. Therefore, any instruction (or combination of instructions) may be utilized in conjunction with a prefix or hint to start a critical section for HLE.

A few examples of instructions that are not typically considered “explicit” lock instructions (but may be used as instructions to manipulate a software lock) include, a compare and exchange instruction, a bit test and set instruction, and an exchange and add instruction. In Intel®'s IA-32 and IA-64 instruction set, the aforementioned instructions include CMPXCHG, BTS, and XADD, as described in Intel®® 64 and IA-32 instruction set documents discussed above. Note that previously decode logic 1325 is configured to detect the instructions utilizing an opcode field or other field of the instruction. As an example, CMPXCHG is associated with the following opcodes: OF BO/r, REX+OF BO/r, and REX.W+OF B lir.

In another embodiment, operations associated with an instruction are utilized to detect a lock instruction. For example, in x86 the following three memory micro-operations are used to perform an atomic memory update of a memory location indicating a potential lock instruction: (1) Load_Store_Intent (L_S_I) with opcode 0×63; (2) STA with opcode 0×76; and (3) STD with opcode O×7F. Here, L_S_I obtains the memory location in exclusive ownership state and does a read of the memory location, while the STA and STD operations modify and write to the memory location. In other words, the lock value at the memory location is read, modified, and then a new modified value is written back to the location. Note that lock instructions may have any number of other non-memory, as well as other memory, operations associated with the read, write, modify memory operations.

In addition, in one embodiment, a lock release instruction is a predetermined instruction or group of instructions/operations. However, just as lock instructions may read and modify a memory location, a lock release instruction may only modify/write to a memory location. As a consequence, in one embodiment, any store/write operation is potentially a lock-release instruction. And similar to the begin critical section instruction, a hint (e.g. prefix) may be added to a lock release instruction to indicate an end of a critical section. As stated above, instructions and stores may be identified by opcode or any other known method of detecting instructions/operations.

In some embodiments, detection of corresponding lock and lock release instructions that define a critical section (CS) are performed in hardware. In combination with prediction, hardware may also include prediction logic to predict critical sections based on empirical execution history. For example, predication logic stores a prediction entry to represent whether a lock instruction begins a critical section or not, i.e. is to be elided in the future, such as upon a subsequent detection of the lock instruction. Such detection and prediction may include complex logic to detect/predict instructions that manipulate a lock for a critical section; especially those that are not explicit lock or lock release.

The techniques described above in reference to critical section detection and prediction solely in hardware is often referred to as Hardware Lock Elision (HLE). However, in another embodiment, such detection is performed in a software environment, such as with a compiler, translator, optimizer, kernel, or even application code; this may be referred to herein as (Speculative Lock Elision or Software Lock Elision (SLE)). Although it's common to refer to SLE and HLE interchangeably in some circumstances, as hardware performs the actual lock elision. Here, software determines critical sections (i.e. identifies lock and lock release pairs). And hardware is configured to recognize software's hints/identification, such that the complexity of hardware is reduced, while maintaining the same functionality.

As a first example, a programmer utilizes (or a compiler inserts) xAcquire and xRelease instructions to define critical sections. Here, lock and lock release instructions are augmented/modified/transformed (i.e. a programmer chooses to utilize xAcquire and xRelease or a prefix to represent xAcquire and xRelease is added to bare lock and lock release instructions by a compiler or translator) to hint at a start and end of a critical section (i.e. a hint that the lock and lock release instructions are to be elided). As a result, code utilizing xAcquire and xRelease, in one embodiment are legacy compliant. Here, on a legacy processor that doesn't support SLE, the prefix of xAcquire is simply ignored (i.e. there is no support to interpret the prefix because SLE is not supported), so the normal lock, execute, and unlock execution process is performed. Yet, when the same code is encountered on a SLE supported processor, then the prefix is interpreted correctly and elision is performed to execute the critical section speculatively.

And since memory accesses after eliding the lock instruction are tentative (i.e. they may be aborted and reset back to the saved register checkpoint state), the accesses are tracked/monitored in a similar manner to monitoring hardware transactions, as described above. When tracking the tentative memory accesses, if a data conflict does occur, then the current execution is potentially aborted and rolled back to a register checkpoint. For example, assume two threads are executing on processor 1300. Thread 1301A detects the lock instruction and is tracking accesses in lower level data cache 1310. A conflict, such as thread 1302A writing to a location loaded from by thread 1301A, is detected. Here, either thread 1301A or thread 1302A is aborted, and the other is potentially allowed to execute to completion. If thread 1301A is aborted, then in one embodiment, the register state is returned to the register checkpoint, the memory state is returned to a previous memory state (i.e. buffered coherency states are invalidated or selected for eviction upon new data requests) and the lock instruction, as well as the subsequently aborted instructions, are re-executed without eliding the lock. Note that in other embodiments, thread 1301a may attempt to perform a late lock acquire (i.e. acquire the initial lock on-the-fly within the critical section as long as the current read and write set are valid) and complete without aborting.

Yet, assume tracking the tentative accesses does not detect a data conflict. When a corresponding lock release instruction is found (e.g. a lock release instruction that was similarly transformed into a lock release instruction with an end critical section hint), the tentative memory accesses are atomically committed, i.e. made globally visible. In the above example, the monitors/tracking bits are cleared back to their default state. Moreover, the store from the lock release instruction to change the lock value back to an unlock value is elided, since the lock was not acquired in the first place. Above, a store associated with the lock instruction to set the lock was elided; therefore, the address location of the lock still represents an unlocked state. Consequently, the store associated with the lock release instruction is also elided, since there is potentially no need to rewrite an unlock value to a location already storing an unlocked value.

In one embodiment, processor 1300 is capable of executing a compiler, optimization, and/or translator code 1377 to compile application code 1376 to support transactional execution, as well as to potentially optimize application code 1376, such as perform re-ordering. Here, the compiler may insert operations, calls, functions, and other code to enable execution of transactions, as well as detect and demarcate critical sections for HLE or transactional regions for RTM.

Compiler 1377 often includes a program or set of programs to translate source text/code into target text/code. Usually, compilation of program/application code 1376 with compiler 1377 is done in multiple phases and passes to transform hi-level programming language code into low-level machine or assembly language code. Yet, single pass compilers may still be utilized for simple compilation. Compiler 1377 may utilize any known compilation techniques and perform any known compiler operations, such as lexical analysis, preprocessing, parsing, semantic analysis, code generation, code transformation, and code optimization. The intersection of transactional execution and dynamic code compilation potentially results in enabling more aggressive optimization, while retaining necessary memory ordering safeguards.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler 1377 potentially inserts transactional operations, calls, functions, etc. in one or more phases of compilation, such as insertion of calls/operations in a front-end phase of compilation and then transformation of the calls/operations into lower-level code during a transactional memory transformation phase. Note that during dynamic compilation, compiler code or dynamic optimization code 1377 may insert such operations/calls, as well as optimize the code 1376 for execution during runtime. As a specific illustrative example, binary code 1376 (already compiled code) may be dynamically optimized during runtime. Here, the program code 1376 may include the dynamic optimization code, the binary code, or a combination thereof.

Nevertheless, despite the execution environment and dynamic or static nature of a compiler 1377; the compiler 1377, in one embodiment, compiles program code to enable transactional execution, HLE and/or optimize sections of program code. Similar to a compiler, a translator, such as a binary translator, translates code either statically or dynamically to optimize and/or translate code. Therefore, reference to execution of code, application code, program code, a STM environment, or other software environment may refer to: (1) execution of a compiler program(s), optimization code optimizer, or translator either dynamically or statically, to compile program code, to maintain transactional structures, to perform other transaction related operations, to optimize code, or to translate code; (2) execution of main program code including transactional operations/calls, such as application code that has been optimized/compiled; (3) execution of other program code, such as libraries, associated with the main program code to maintain transactional structures, to perform other transaction related operations, or to optimize code; or (4) a combination thereof.

Often within transactional memory environment, a compiler will be utilized to insert some operations, calls, and other code in-line with application code to be compiled, while other operations, calls, functions, and code are provided separately within libraries. This potentially provides the ability of the software distributors to optimize and update the libraries without having to recompile the application code. As a specific example, a call to a commit function may be inserted inline within application code at a commit point of a transaction, while the commit function is separately provided in an updateable STM library. And the commit function includes an instruction or operation, when executed, to reset monitor/attribute bits, as described herein. Additionally, the choice of where to place specific operations and calls potentially affects the efficiency of application code. As another example, binary translation code is provided in a firmware or microcode layer of a processing device. So, when binary code is encountered, the binary translation code is executed to translate and potentially optimize the code for execution on the processing device, such as replacing lock instruction and lock release instruction pairs with xAcquire and xEnd instructions (discussed in more detail below).

In one embodiment any number of instructions (or different version of current instructions) are provided to aid thread level speculation (i.e. transactional memory and/or speculative lock elision). Here, decoders 1325 are configured (i.e. hardware logic is coupled together in a specific configuration) to recognize the defined instructions (and versions thereof) to cause other stages of a processing element to perform specific operations based on the recognition by decoders 1325. An illustrative list of such instructions include: xAcquire (e.g. a lock instruction with a hint to start lock elision on a specified memory address); xRelease (e.g. a lock release instruction to indicate a release of a lock, which may be elided); SLE Abort (e.g. abort processing for an abort condition encountered during SLE/HLE execution) xBegin (e.g. a start of a transaction); xEnd (e.g. an end of a transaction); xAbort (e.g. abort processing for an abort condition during execution of a transaction); test speculation status (e.g. testing status of HLE or TM execution); and enable speculation (e.g. enable/disable HLE or TM execution).

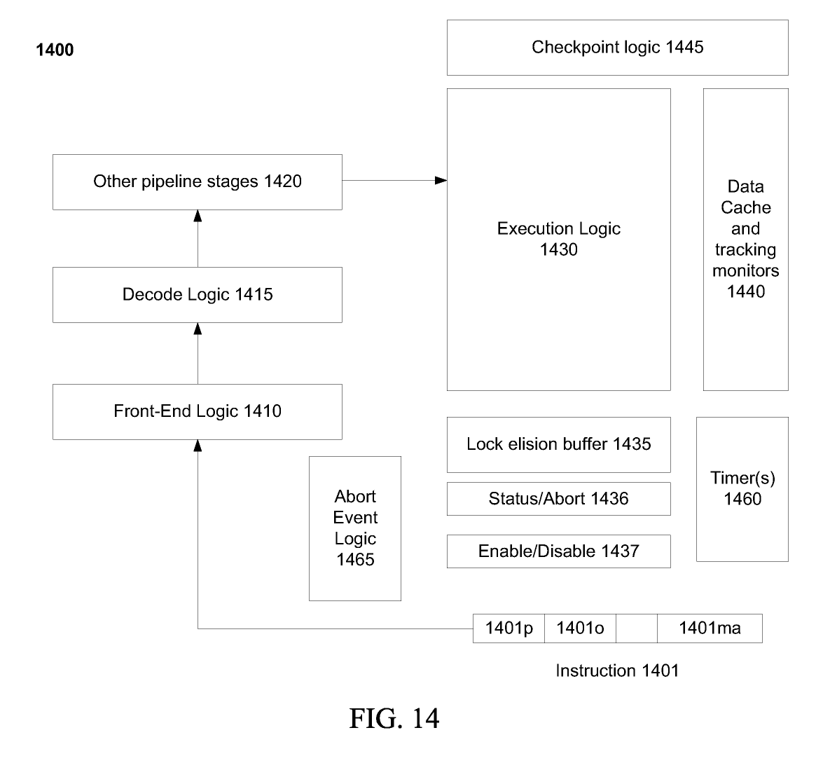

Referring next to FIG. 14, an embodiment of modules/logic to provide abort control mechanisms is illustrated. As an example, single instruction 1401 is illustrated; however, numeral 1401 will be discussed in reference to a number of instructions that may be supported by processor 1400 for thread level speculation (e.g. exemplary instruction implementations are demonstrated through pseudo code in FIGS. 6-7). Specifically, a single instruction (instruction 1401) is shown for simplicity. However, as each example and figure is discussed, different instructions are presented in reference to instruction 1401. In one scenario, instruction 1401 is an instruction that is part of code, such as application code, user-code, a runtime library, a software environment, etc. And instruction 1401 is recognizable by decode logic 1415. In other words, an Instruction Set Architecture (ISA) is defined for processor 1400 including instruction 1401, which is recognizable by operation code (op code) 1401o. So, when decode logic 1415 receives an instruction and detects op code 1401o, it causes other pipeline stages 1420 and execution logic 1430 to perform predefined operations to accomplish an implementation or function that is defined in the ISA for specific instruction 1401.

As discussed above, two types of thread level speculation techniques are primarily discussed herein—transactional memory (TM) and speculative lock elision (SLE). Transactional memory, as described herein, includes the demarcation of a transaction (e.g. with new begin and end transactional instructions) utilizing some form of code or firmware, such that a processor that supports transactional execution (e.g. processor 1400) executes the transaction tentatively in response to detecting the demarcated transaction, as described above. Note that a processor, which is not transactional memory compliant (i.e. doesn't recognize transactional instructions, which are also viewed as legacy processors from the perspective of new transactional code), are not able to execute the transaction, since it doesn't recognize a new opcode 14010 for transactional instructions.

In contrast, SLE (in some embodiments) is made legacy compliant. Here, a critical section is defined by a lock and lock release instruction. And either originally (by the programmer) or subsequently (by a compiler or translator) the lock instruction is augmented with a hint to indicate locks for the critical section may be elided. Then, the critical section is executed tentatively like a transaction. As a result, on an SLE compliant processor, such as processor 1400, when the augmented lock instructions (e.g. lock instructions with associated elision hints) are detected, hardware is able to optionally elide locks based on the hint. And on a legacy processor, the augmented portions of the lock instructions are ignored, since the legacy decoders aren't designed or configured to recognize the augmented portions of the instruction. Note that in one scenario, then augmented portion is an intelligently selected prefix that legacy processors were already designed to ignore, but newly designed processors will recognize. Consequently, on legacy processors, the critical section is executed in a tradition manner with locks. Here, the lock may serialize threaded access to shared data (and therefore execution), but the same code is executable on both legacy and newly designed processors. So, processor designers don't have to alienate an entire market segment of users that want to be able to use legacy software on newly designed computer systems.

To provide an illustrative operating environment for a better understanding, two oversimplified execution examples—execution of a critical section utilizing SLE and execution of a transaction utilizing TM—are discussed in reference to processor 1400 of FIG. 14.

Starting with the first example, assume program code includes a critical section. The start of the critical section, in this example, is defined by a lock acquire instruction 1401; whether utilized by the programmer or inserted by compiler/translator/optimizer code. As discussed above, a lock acquire instruction includes a previous lock instruction (e.g. identified by opcode 1401o) augmented with a hint (e.g. prefix 1401p). In one embodiment, a lock acquire instruction 1401 includes an xAcquire instruction with a SLE hint prefix 1401p added to a previous lock instruction. Here, the SLE hint prefix 1401p includes a specific prefix value that indicates to decode logic 1415 that the lock instruction referenced by opcode 14010 is to start a critical section.

As stated above, a previous lock instruction may include an explicit lock instruction. For example, in IntellO's current IA-32 and Intel®® 64 instruction set an Assert Lock# Signal Prefix, which has opcode FO, may be pre-pended to some instructions to ensure exclusive access of a processor to a shared memory. Or the previous lock acquire instruction includes instructions that are not “explicit,” such as a compare and exchange instruction, a bit test and set instruction, and an exchange and add instruction. In IntellO's IA-32 and IA-64 instruction set, the aforementioned instructions include CMPXCHG, BTS, and XADD, as described in Intel®® 64 and IA-32 instruction set documents. In these documents CMPXCHG is associated with the following opcodes: OF BO/r, REX+OF BO/r, and REX.W+OF B lir. Yet, a lock acquire instruction (in some embodiments) is not limited to a specific instruction, but rather the operations thereof. For example, in x86 the following three memory micro-operations are used to perform an atomic memory update of a memory location indicating a potential lock instruction: (1) Load_Store_Intent (L_S_I) with opcode 0×63; (2) STA with opcode 0×76; and (3) STD with opcode O×7F. Here, L_S_I obtains the memory location in exclusive ownership state and does a read of the memory location, while the STA and STD operations modify and write to the memory location. In other words, the lock value at the memory location is read, modified, and then a new modified (locked) value is written back to the location. Note that lock instructions may have any number of other non-memory, as well as other memory, operations associated with the read, write, modify memory operations.

In a first usage of xAcquire 1401, a programmer creating application or program code utilizes xAcquire to demarcate a beginning of a critical section that may be executed using SLE (i.e. either through a higher-level language or other identification of a lock instruction that is translated into SLE hint prefix 1401p associated with opcode). Essentially, a programmer is able to create a versatile program that is able to run on legacy processors with traditional locks or on new processors utilizing HLE. In another usage, either as part of legacy code or by the choice (or lack of knowledge of newer programming techniques) of the programmer, a traditional lock instruction (examples of which are discussed immediately above) is utilized. And code (e.g. a static compiler, a dynamic compiler, a translator, an optimizer, or other code) detects critical sections within the program code. The detection is not discussed in detail; however, a few examples are given. First, any of the instructions or operations above are identified by the code and replaced or modified with xAcquire instruction 1401. Here, prefix 1401p is appended to previous instruction 1401 (i.e. opcode 14010 with any other instruction and addressing information, such as memory address 140 1ma). As another example, the code tracks stores/loads of application code and determines lock and lock release pairs that define a potential critical section. And as above, the code inserts xAcquire instruction 1401 at the beginning of the critical section.

In a very similar manner, xRelease is utilized at the end of a critical section. Therefore, whether the end of a critical section (e.g. a lock release) is identified by the programmer or by subsequent code, xRelease is inserted at the end of the critical section. Here, xRelease instruction 1401 has an opcode that identifies an operation, such as a store operation to release a lock (or a no-operation in an alternative embodiment), and a xRelease prefix 1401p to be recognized by SLE configured decoders.

In response to decoding xAcquire 1401, processor 1400 enters HLE mode. HLE execution is then started i. In one embodiment, the current register state is checkpointed (stored) in checkpoint logic 1445 in case of an abort. And memory sate tracking is started (i.e. the hardware monitors described above begin to track memory accesses from the critical section). For example, accesses to a cache are monitored to ensure the ability to roll-back (or discard updates to) the memory state in case of an abort. If the lock elision buffer 1435 is available, then it's allocated, address and data information is recorded for forwarding and commit checking, and elision is performed (i.e. the store to update a lock at the memory address 140 1ma is not performed). In other words, processor 1400 does not add the address of the lock to the transactional region's write-set nor does it issue any write requests to the lock. Instead, the address of the lock is added to the read set, in one example. And the lock elision buffer 1435, in one scenario, includes the memory address 140 1ma and the lock value to be stored thereto. As a result, a late lock acquire or subsequent execution may be performed utilizing that information. However, since the store to the lock is not performed, then the lock globally appears to be free, which allows other threads to execute concurrently with the tracking mechanisms acting as safeguards to data contention. Yet, from a local perspective, the lock appears to be obtained, such that the critical section is able to execute freely. Note that if lock elision buffer 1435 is not available, then in response the lock operation is executed atomically without elision.

As can be seen, within the critical section, execution behaves like a transaction (free, concurrent execution with monitors and contention protocols to detect conflicts, such that multiple threads are not serialized unless an actual conflict is detected). Note that SLE/HLE enabled software is provided the same forward progress guarantees by processor 1400 as the underlying non-HLE lock-based execution. In other words, if tentative or speculative execution of a critical section with HLE fails, then the critical section may be re-executed with a legacy locking system. Also, in some embodiment, processor 1400 is able transition to non-transactional execution without performing a transactional abort.

Once the end of the critical section is reached, then the xRelease instruction 1401 is fetched by the front-end logic 1410 and decoded by decode logic 1415. As stated above, xRelease instruction 1401, in one embodiment, includes a store to return the lock at memory address 140 1ma back to an unlocked value. However, if the original store from the xAcquire instruction was elided, then the lock at memory address 140 1ma is still unlocked (as long as not other thread has obtained the lock). Therefore, the store to return the lock in xRelease is unnecessary.

Consequently, decoders 1415 are configured to recognize the store instruction from opcode 14010 and the prefix 1401p to hint that lock elision on the memory address 140 1ma specified by xAcquire and/or xRelease is to be ended. Note that the store or write to lock 140 1ma is elided when xRelease is to restore the value of the lock to the value it had prior to the XACQUIRE prefixed lock acquire operation on the same lock. However, in a versioning system (i.e. incrementing metadata values in locks to determine a most recent transaction/critical section to commit) the lock value may be incremented. Here, xRelease is to hint at an end to elison, but the store to memory address 140 1ma is performed. A commit of the critical section is completed, elision buffer 1435 is deallocated, and HLE mode is exited.

As mentioned above, in some legacy hardware implementations that do not include HLE support, the XACQUIRE and XRELEASE prefix hints are ignored. And as a result, elision will not be performed, since these prefixes, in one embodiment, correspond to the REPNE/REPE IA-32 prefixes that are ignored on the instructions where XACQUIRE and XRELEASE are valid. Moreover, improper use of hints by a programmer will not cause functional bugs, as elison execution will continue correct, forward progress.

As aforementioned, if an abort condition (data contention, lock contention, mismatching lock address/values, etc.) is encountered, then some form of abort processing may be performed. Just as transactional memory and HLE are similar in execution, they may also be similar in portions of abort processing. For example, checkpointing logic 1445 is utilized to restore a register state for processor 1400. And the memory state is restored to the previous critical section state in data cache 1440 (e.g. monitored cache locations are invalidated and the monitors are reset). Therefore, in one embodiment, the same or a similar version of the same abort instruction (xAbort 1401) is utilized for both SLE and TM. Yet in another embodiment, separate xAbort instructions (with different opcodes and/or prefixes) are utilized for HLE and TM. Moreover, abort processing for HLE may be implicit in hardware (i.e. performed as part of hardware in response to an abort condition without an explicit abort instruction). In some implementations, the abort operation may cause the implementation to report numerous causes of abort and other information in either a special register or in an existing set of one or more general purpose registers. The control mechanisms for aborting a speculative code region are discussed in more detail below.

As a reminder, two oversimplified execution examples—execution of a critical section utilizing SLE and execution of a transaction utilizing TM—are currently being discussed. The exemplary execution of a critical section utilizing xAcquire and xRelease has been covered. Therefore, the description now moves to discussion of exemplary execution of a transaction using transactional memory—also referred to as Restricted Transactional Memory (RTM) or Hardware transactional Memory (HTM)—techniques.

Much like a critical section, a transaction is demarcated by specific instructions. However, in one embodiment, instead of a lock and lock release pair with prefixes, the transaction is defined by a begin (xBegin) transaction instruction and end (xEnd) transaction instruction (e.g. new instructions instead of augmented previous instructions). And similar to SLE, a programmer may choose to use xBegin and xEnd to mark a transaction. Or software (e.g. a compiler, translator, optimizer, etc.) detects a section of code that could benefit from atomic or transactional execution and inserts the xBegin, xEnd instructions.

As an example, a programmer uses the XBEGIN instruction to specify a start of the transactional code region and the XEND instruction to specify the end of the transactional code region. Therefore, when a xBegin instruction 1401 is fetched by fetch logic 1410 and decoded by decode logic 1415, processor 1400 executes the transactional region like a critical section (i.e. tentatively while tracking memory accesses and potential conflicts thereto). And if a conflict (or other abort condition) is detected, then the architecture state is rolled back to the state stored in checkpoint logic 1445, the memory updates performed during RTM execution are discarded, execution is vectored to the fallback address provided by the xBegin instruction 1401, and any abort information is reported accordingly. Here, an XEND instruction is to define an end of a transaction region. Often the region execution is validated (ensure that no actual data conflicts have occurred) and the transaction is committed or aborted based on the validation in response to an XEND instruction. In some implementations, XEND is to be globally ordered and atomic. Other implementations may perform XEND without global ordering and require programmers to use a fencing operation. The XEND instruction, in one embodiment, may signal a general purpose exception (#GP) when used outside a transactional region.

The two examples of speculative code region execution—HLE and RTM—have been discussed above. And in reference to both of these examples, the focus on instructions and the format thereof has been on the boundary instructions (e.g. acquire, release, begin, and end). However, discussion of the instructions available within a speculative code region is also worthwhile.

In one embodiment, once a speculative code region is started by an XAQURIE OR XBEGIN, then the subsequent instruction are, by default, assumed to be speculative (i.e. transactional). Here, a programmer includes a new XBEGIN instruction for a transaction. But the memory access operations are typical, previous memory instructions, such as MOV rxx, mxx. And since they are included within a defined transaction, they instructions are treated as transactional memory access operations.

In an alternative embodiment, instructions/operations within a code region are, by default, non-transactional. Here, new transactional memory access operations (either identified by new opcodes or new prefixes added to old instructions) are utilized. As an example, if a previous MOV r32, m32 instruction is utilized within a transaction, then it's treated non-transactionally by default; which in some cases may cause an abort. However, if the MOV r32, m32 is associated with a transactional prefix or an XNMOV r32, m32 with a new transactional opcode is utilized then the instruction is treated transactionally.

Although alternative embodiments for how operations within a specualtive code region are discussed above, in another embodiment, transactional and non-transactional operations, may be mixed within a speculative code region. Here, assume operations within a speculative code region are treated trasnsactionally (or tentatively) by default. In this scenario, the ISA may define explicit non-transactional instructions, such as XNMOV r32, m32 and XNMOV m32, r32, that allow a programmer to ‘escape’ the speculative nature of a code region and perform a non-transactional memory operation.

Also note that, in one embodiment, different defaults may be utilized for HLE versus TM. For example, within HLE sections operations may be interpreted as non-transactional in nature, since the original programmer may have initially contemplated non-transactional operations protected by locks, while a compiler or other software transformed this code region into a critical section to be executed by lock elision. And in this example, TM sections may by interpreted by default as transactional.

In both instances of the example speculative code region execution (e.g. HLE and TM) there was mention of aborting the speculative code regions. And furthermore, there was some discussion of how the end result abort processing may be performed (i.e. checkpoint logic 1445 rolls-back an architectural state of processor 1400—or the processing element of processor 1400—to a checkpoint at the start of the speculative code region and the tentative updates to memory (memory state) are discarded in cache 1440. Yet, to this point there has been no specific discussion of how the abort decision is made or the control mechanisms thereof.

In one embodiment, processor 1400 includes abort event logic 1465 configured to track potential speculative code region abort events. And a decision is made whether a speculative code region is to abort based on policies defined in hardware, firmware (e.g. microcode), code (e.g. privileged hypervisor or application code), or a combination thereof. As illustrated, abort event logic 1465 is illustrated as separate from other logic/modules of processor 1400. However, just as the other depicted representations of logical modules may cross/overlap other boundaries, so may abort event logic 1465.

For example, a common speculative code region abort event includes detection of a conflict regarding a memory address within the code region's read or write set. Here, assume cache 1440 includes a cache line with a read monitor set for a current speculative code region. And a snoop to write from another processing element on processor 1400 is made to the cache line, so the other processing element can obtain the line in an exclusive state and modify it. In this scenario, cache control logic indicates a conflict (i.e. the cache line is marked as transactionally read as part of the read set and an external processing element wants to write to the line). Therefore, in one embodiment (as discussed in more detail below) this conflict is recorded in abort status register 1436. As can be seen from this example, detection of the potential abort event was purely made within cache 1440. But in one embodiment, reference to abort event logic 1465 includes cache 1440's logic to perform the conflict detection. As can be seen, any defined abort event may have distributed logic to detect the abort event. As another example, timer(s) 1460 may be utilized to timeout a speculative code region to ensure forward progress. So the timer and expiration thereof, in one embodiment, is considered within or part of abort event logic 1465.

Once one or more aborts are defined (i.e. tracked in register 1436), then the interpretation of the potential abort event becomes the topic of conversation. In one embodiment, hardware defines the abort policy. As an example, abort storage element 1436 holds a representation of detected abort events. And logic combinations are configured in a specific manner to define what abort events are ignored or cause an abort of the code speculative region. As a purely oversampled and illustrative example, assume a hardware designer always wants to abort when an explicit abort instruction is detected or when a data conflict is detected. Here, assuming a logical high represents an abort occurring and a logical high output initiates and actual abort, then an OR logical gate (or inverted NOR gate) is coupled to the bit positions of abort status register 1436 corresponding to the data conflict and explicit abort events. Therefore, if either bit position is set high upon an occurrence of the event, then the resulting logical high from the OR logical gate for an abort control signal initiates an abort of the speculative code region. Extrapolating from this simple example, hardware may predefine abort events that are handled normally, ignored, or sent to firmware or software for interpretation. And in one implementation, hardware may allow firmware or software to dynamically update its default abort policies (i.e. control mechanisms). Moreover, in some implementations, it may be advantageous to enable an ‘always abort’ speculative code region, so designers/programmers are able to test/debug abort fall back paths (e.g. a fall back defined in hardware, a fall back defined by an XBEGIN instruction, and/or a fall back defined by an XBORT argument). Here, one or more bits in a register, such as abort register 1436 is set (by hardware, firmware, and/or software) to an abort value to indicate to hardware that all speculative code regions are to be aborted. In this scenario, hardware automatically interprets the always abort indication as an abort.

In the previous example, hardware defined the potential abort events for detection and defined what scenario (single or combination of those events) would cause an abort of a speculative code region. However, in other embodiments, both the definition of abort events to track and the scenarios for causing an abort may be defined by hardware, firmware, software, or a combination thereof. As an example, a mask may provide access to different privilege levels of software to abort register 1436 to define what abort events to track. Note the mask may allow hardware to predefine a few abort events that are always tracked (and/or always cause an abort) to guarantee forward progress, while enabling software to turn on/off tracking of other abort events/conditions. Furthermore, different levels of decisions may be made (e.g. hardware makes an initial determination of whether or not to even inform code of the abort conditions tracked; and if software is informed, then it makes a decision whether to abort based on the informed abort events). Or in another embodiment, hardware automatically initiates an abort of a speculative code region when specific abort conditions (e.g. an explicit abort instruction, data conflict, memory operation type, timer expiration etc.) are detected. But hardware leaves the decision for other abort conditions (e.g. memory ordering, internal buffer overflow, or an I/O access) to software.

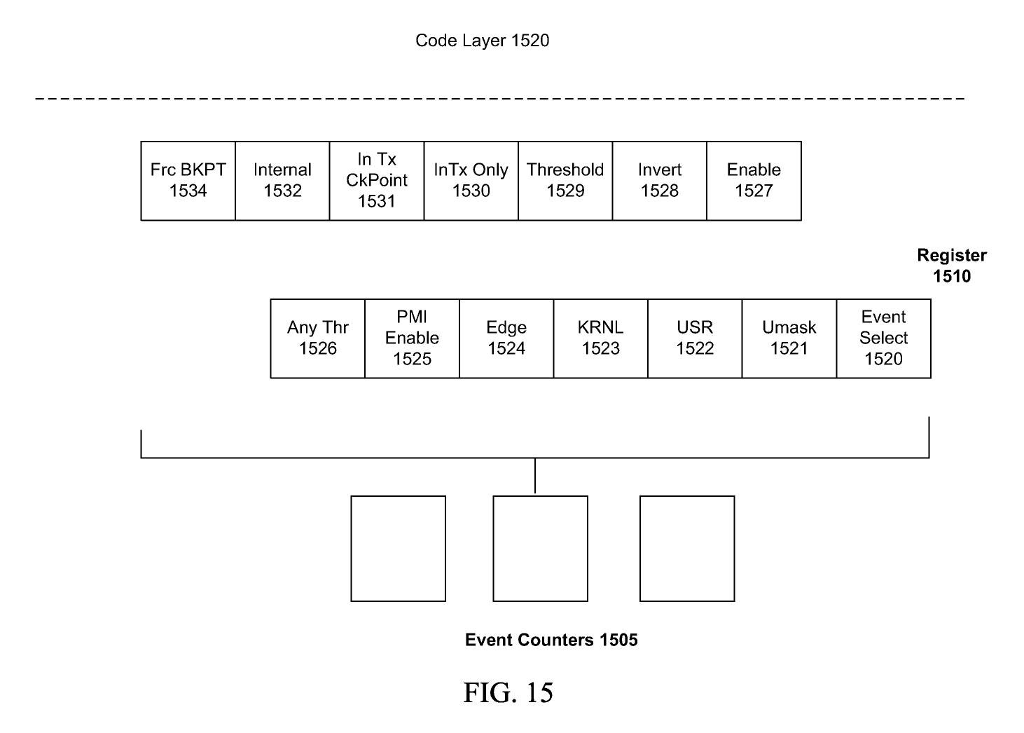

Referring next to FIG. 15, an embodiment of a programmable register to control event counter tracking and performance tuning. Register 1510 includes any known register type (e.g. a general purpose register, a special register, a Model-Specific Register (MSR)). In one embodiment, register 1510 is replicated per programmable or controllable event counters (i.e. each programmable counter 1505 is associated with a register similar to register 1510). In another embodiment, register 1510 is to control a bank (i.e. more than one) counters 1505.

As depicted, code layer 1520 is to access (i.e. read, write, or both) register 1510. As a first example, code layer 1520 includes a light weight profiling or performance application to monitor performance and/or tune a processor based on performance metrics. Note that such an application may be a user-level application, privileged-level application, micro-code function, or a combination thereof. And although layer 1520 is referred to as a ‘code layer’, it is not so restricted. Instead, a hardware based performance unit, which may also include collocated performance code, may perform the same programming of register 1510 to control one or more of counters 1505. As another example, code layer 1520 includes microcode, program code, user-level code, compiler code, privileged-level code, OS kernel code, or other code operable to program register 1510.

Register 1510 in the depicted embodiment includes a number of fields (i.e. defined locations to hold one or more bit values that encode/represent control of or information about one or more of counter 1510. Event Select 1520 is used to select the events to be monitored (e.g. encodes an event or event type to be counted/monitored); Umask 1521 is a unit mask to select sub-events to be selected for creation of the event (e.g. the selected sub-events are OR-ed together to create an event, such as a scenario of events); USR 1522 specifies that events are counted only when the processor is operating at current privilege levels 1, 2 or 3 (CPL !=0); KRNL 1523 specifies that events are counted only when the processor is operating at current privilege level 0 (CPL=0); Edge 1524 indicates edge detection detects when an event has crossed the threshold value and increments the counter by 1; PMI 1525 includes an APIC interrupt enable, when set, to generate an exception through its local APIC on counter overflow for this counter's thread; Any Thr 1526 controls whether the counter counts events for all threads or the counter-specific thread; enable 1527 is the local enable for an associated performance monitor counter (perfMon counter); invert 1528 indicates how the threshold field will be compared to the incoming event (e.g. when ‘0’, the comparison that will be done is: threshold >=event and when set to ‘1’, the comparison that will be done is inverted from the case where this bit is set to ‘0’: threshold less than event); Threshold 1529 indicates when nonzero, the counter compares this mask to the size of the event entering the counter. And if the event size is greater than or equal to this threshold, the counter is incremented by one; otherwise the counter is not incremented); inTX Only 1530: Setting this bit to '1 restricts the counter to only incrementing for the programmed event during speculative and non-speculative HLE mode (e.g. the embodiment described above where counter 660 may be utilized to count events in a speculative code region); Checkpoint 1531, if enabled, the event count will exclude events that occurred on an aborted TX region; Force BkPt 1534 when set a MicroBreakPoint occurs each time a none zero Event enters the counter. Note that each of these fields and their potential use is purely illustrative. Some of these fields may be omitted, while others that are not depicted may be included.

A common example of comparing committed versus total (including uncommitted) or just uncommitted event counts includes instruction retirement counting. Here, from the difference between uncommitted vs committed counts, it's possible to determine how effectively transactional (or HLE) regions are being used in the machine. If the uncommitted count was significantly higher than committed instruction counts, for example, it could indicate that the parameters of a speculative feature is not optimized. And as a result, the processor is throwing away too much work. The user could run (e.g. a user profiling program) studies adjusting the parameters of the transaction behavior and use the counter differences (committed vs uncommitted) to determine whether those adjustments were effective (the smaller the difference between the committed vs uncommitted counts could indicate the transaction regions are executing more efficiently since less work is being discarded). There are no restrictions on which events can be used with counter checkpointing. And other examples of events that may similarly be useful include: cycles, branches, branch mispredicts, etc.. Different events used with counter checkpointing can target specific parts of the transaction algorithm users may want to tune.

Before discussion of embodiments for implementations of some methods for speculative counter control, it's also important to note that such implementations are depicted in the format of flow diagrams. These flows may be performed by hardware, firmware, microcode, privileged code, hypervisor code, program code, user-level code, or other code associated with a processor. For example, in one embodiment, hardware is specifically configured or adapted to perform the flows. Note that having hardware or logic configured and/or specifically designed to perform one or more flows is different from general logic that is just operable to perform such a flow by execution of code. Therefore, logic configured to perform a flow includes hardware logic designed to perform the flow. Additionally, the actual performance of the flows may be viewed as a method of performing, executing, enabling or otherwise carrying out such counter control for speculative regions. Here, code may be specifically designed, written, and/or compiled to perform one or more of the flows when executed by a processing element.

However, each of the illustrated flows are not required to be performed during execution. Furthermore, other flows that are not depicted may also be performed. Moreover, the order of operations in each implementation is purely illustrative and may be altered.

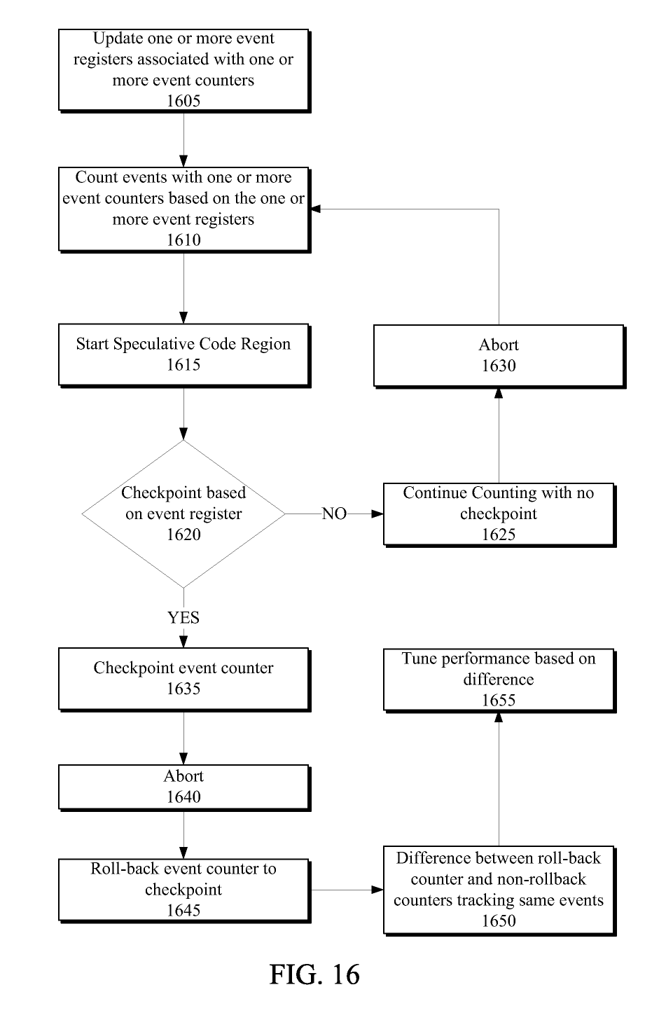

Turning to FIG. 16, an embodiment of a flow diagram for controlling an event counter during speculative execution and performance tuning based thereon is illustrated. Before the specific discussion of embodiments for controlling event counters, it's important to note that such implementations are depicted in the format of flow diagrams. These flows may be performed by hardware, firmware, microcode, privileged code, hypervisor code, program code, user-level code, other code associated with a processor, or a combination thereof. Additionally, hardware that is configured (i.e. specifically designed and/or connected in a manner) to perform the depicted flows may be viewed as an apparatus configured to perform such flows, not just an apparatus capable of performing such operations with general logic. In other words, a general processor that is able to execute code to perform the flows may contribute to or be capable of performing the flows through the execution of the code. However, an apparatus configured to perform the flows includes connected hardware logic to perform the associated flows. Furthermore, code may be specifically designed, written, and/or compiled to perform one or more of the flows when execution by a processing element. And such code may be held on a readable medium (as described in more detail below), such that when it's executed by a machine or processing device, the device performs the flows. However, each of the illustrated flows are not required to be performed during execution. And additionally, other flows that are not depicted may also be performed. Moreover, the order of operations in each implementation is purely illustrative and may be altered.

In flow 1605, one or more event registers, such as register 1510, is updated. As an example, software (e.g. privileged level code, a user-application, performance/profiling application, or other known code) writes to the register updating one or more fields to define associated event counter operations. For example, the write updates an enable field to enable checkpointing for speculative execution, updates an event selection field to indicate an event or event type to count, and/or updates any other known field for controlling or providing information from/to a performance counter.

Depending on the implementation, different levels of code may be provided more or less access to a counter control register (and thereby an associated performance/event counter). As an illustrative example, certain portions of register 1510 are not accessible by user-level software, but are available to privileged level software. As another example, event selection field 1520 encodes a number of events to be selected for tracking. But user level application is allowed to only select from a subset of the number of events to track, while more privileged level software (e.g. hypervisor, OS code, and/or microcode) are allowed to select more events, which may also be in a graduated access level based on privilege level.

In response to an event type, an event, and/or a start defined by the write to the register, the counter starts counting events in flow 1610. Here, a counter may count event instances (i.e. a number of time an event occurs), event durations (i.e. a number of cycles an event occurs for), or durations between events (i.e. number of cycles between defined events) based on the event selection made in the write to the register. In flow 1615, a speculative code region is started. Here, a start to speculation may include a predicted branch, an XBEGIN instruction to start execution of a transaction, an XACQUIRE instruction to start execution of a critical section, or other known start to speculation. In flow 1620 it's determined if the event register should be checkpointed. In one scenario, the checkpoint is to be performed in response to a field in the counter control register, such as a speculative checkpoint enable field, being set to an enable value, such that when speculation is encountered the hardware automatically checkpoints the associated counter. In another embodiment, certain attributes or a predefined flow of the start speculation instruction causes the event counter to be checkpointed (i.e. the event count of the counter to be stored, maintained, and/or preserved).

If a checkpoint is determined to not be performed in flow 1620, then the event counter continues counting events (as defined by its non-programmable, default nature or by the event selection in the control register) without performing a checkpoint of the event count value. And if an abort occurs in flow 1630, then the counter still continues to count events until a programmable control register for the counter performs another update in flow 1605. However, if a checkpoint is to be performed, then in flwo 1635 the event counter is checkpointed (e.g. the event count value at that point in execution is stored and perserved). And if an abort of the speculative code region is encountered in flow 1640, then the event counter is rolledback to the preserved, checkpoint value (i.e. the counter is restored to the event count at the start of speculation).

In one embodiment, a rollback counter and non-rollback counter is utilized to track the same events. So if an abort and rollback occurs, then the difference between the two counters indicates a number of events tracked during speculation before the abort in flow 1650. Note in an alternative embodiment, a single counter may be utilized to obtain this same information. Here, before rolling back a counter, the difference between the counter value at abort and the checkpointed counter value provides similar information. However, use of a second counter potentially avoids the untimely rollback before the difference is obtained, as well as provides a running count (i.e. an accumulation) of events tracked during committed and uncommitted execution.

Event information regarding an aborted (uncommitted) speculative code section may then be utilized to tune performance in flow 1655. For example, assume a light weight profiling (LWP) application (app) is executing. And the LWP app writes to register 1510 to indicate that it is to track a number of retirement pushouts between sequential operations that exceed a specific cycle threshold and is to be checkpointed at the start of a transaction or critical section. Furthermore, the LWP app programmed a second register in a similar manner to track the same event but to not be checkpointed. Upon reaching an abort, the difference between the counters is determined in flow 1650.

That difference is then provided to the LWP app, which according to its policy, tunes hardware, software, firmware, or a combination thereof. In one embodiment, tuning includes modifying, enabling, disabling, or otherwise affecting an architectural or micro architectural feature. As a first example, the size of the feature is altered, the feature is enabled, the feature is disabled, or policies associated with the feature are altered based on which action reduces latency in a critical path. As an illustrative example of this tuning, hardware lock elison may be disabled if too many instruction retirement pushouts over a threshold are detected (i.e. decode logic is informed to ignore hints from the XACQUIRE instruction and to execution critical sections normally with eliding lock instruction stores). In another embodiment, tuning includes modifying software. Here, the speculative code section may be optimized or dynamically recompiled to remove the XACQUIRE hint, such that a tradition lock instruction is left. Note these examples are purely illustrative. And any known event (and difference of event counts for an uncommitted section of code) may be utilized to tune hardware, software, firmware, or a combination thereof in any known manner.

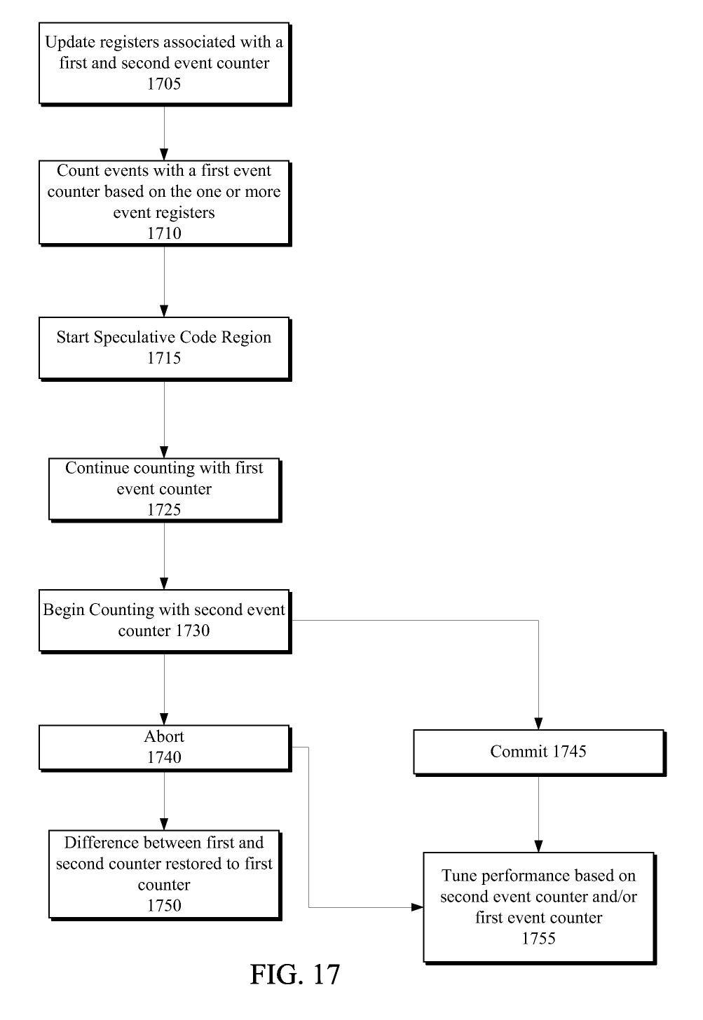

Referring next to FIG. 17, another embodiment of a flow diagram for speculative counter control is illustrated. In flow 1705, registers are updated for a first and second counter. For example, programmable registers accessible by privileged level software, user-level, software, or a combination thereof are programmed to indicate an event to tack. Furthermore, in this scenario, a first register is programmed to indicate that the first counter is to tack the event type (e.g. instruction retirement) regardless of the speculative nature of code. And similarly, a second register for the second counter is programmed to only track instruction retirements within speculative regions (e.g. transactional or critical sections).

In flow 1710, the first counter starts counting events. And in flow 1715, as in FIG. 16, a speculative code region is started. As a result of the programming, the first counter continues counting in flow 1725, and the second counter starts counting events in flow 1730. As a result, the first counter is tracking events for both committed and uncommitted execution, while the second counter is tracking uncommitted events (i.e. events that occur in the transaction or critical section). At any time (including at commit 1745), the counter represent these values, so hardware, firmware, software or a combination thereof may tune performance (i.e. the hardware or software) based on the second counter (i.e. the events tracked in the speculative code region) or a combination thereof (i.e. the events tracked in the speculative code region versus a total number of events or a number of events tracked before the speculative code region). And furthermore, upon an abort in flow 1740, the first counter is rolledback to a point before the start of the speculative code region (i.e. the total number of events held in the first counter less the number of events tracked during speculative execution held in the second counter), which is easily obtained through subtraction of the second counter value from the first counter value.

Consequently, profiling and performance hardware/software may utilize programmable counters to accumulate both committed and uncommitted execution, determine performance metrics/events in an uncommitted speculative region, and tune features of hardware/software/firmware based thereon.

A module as used herein refers to any hardware, software, firmware, or a combination thereof. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices. However, in another embodiment, logic also includes software or code integrated with hardware, such as firmware or micro-code.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A system comprising:
a plurality of processors;
a first interconnect to couple two or more of the plurality of processors;
a second interconnect to couple one or more of the plurality of processors to one or more other system components;
a system memory coupled to one or more of the processors;
wherein at least one processor of the plurality of processors comprises:
a plurality of symmetric cores, at least one of the symmetric cores to simultaneously process a plurality of threads and to perform out-of-order instruction processing for the plurality of threads;
at least one shared cache circuit to be shared among two or more the of symmetric cores;
event counter circuitry comprising:
a plurality of event counters including programmable event counters and fixed event counters;
one or more configuration registers to store configuration data to specify an event type to be counted by the programmable event counters, wherein at least one of the one or more configuration registers is to store configuration data for a plurality of the programmable event counters;
transactional memory circuitry to process transactional memory operations including load operations and store operations, the transactional memory circuitry to process a transaction begin instruction to indicate a start of a transactional execution region of a program, a transaction end instruction to indicate an end of the transactional execution region, and a transaction abort instruction to abort processing of the transactional execution region;
transaction checkpoint circuitry to store a processor state at the start of the transactional execution region of the program, the processor state including values of one or more of the event counters; and
lock elision circuitry to cause critical sections of the program to execute as transactions on multiple threads without acquiring a lock, the lock elision circuitry to cause the critical sections to be re-executed non-speculatively using one or more locks in response to detecting a transaction failure.

2. The system of claim 1, wherein the transaction is a first transaction and the first transaction fails if data loaded by the first transaction is modified by a second transaction.

3. The system of claim 1, wherein the transaction checkpoint circuitry is to restore the processor state stored by the transaction checkpoint circuitry responsive to a transaction failure.

4. The system of claim 1, wherein at least one of the symmetric cores comprises:
an instruction fetch circuit to fetch instructions of one or more of the threads;
an instruction decode circuit to decode the instructions;
a register renaming circuit to rename registers of a register file;
an instruction cache to store instructions to be executed;
a data cache to store data;
at least one buffer to store entries associated with pending load and store instructions.

5. The system of claim 1, further comprising cache control circuitry to indicate whether data has been speculatively read from a cache line.

6. The processor of claim 2 wherein the at least one bit is to be cleared upon completion of the transactional region.

7. The system of claim 1 wherein the second interface comprises a Peripheral Component Interface (PCI) Express interface.
